(19) United States
(12) Patent Application Publication
(10) Pub. No.: US 2018/0144276 A1
(43) Pub. Date: May 24, 2018

(54) SYSTEM, METHOD AND APPARATUS FOR CONVERTING THE BUSINESS PROCESSES TO TEST-CENTRIC ACTIVITY DIAGRAMS

(71) Applicant: M/S. Cigniti Technologies Limited, Madhapur (IN)

(72) Inventor: Raja Sekhar Neravati, Hyperbad (IN)

(73) Assignee: M/S. Cigniti Technologies Limited, Madhapur (IN)

(21) Appl. No.: 15/874,010

(22) Filed: Jan. 18, 2018

Related U.S. Application Data
(63) Continuation-in-part of application No. 14/680,132, filed on Apr. 7, 2015.
(60) Provisional application No. 61/976,522, filed on Apr. 8, 2014.

(51) Int. Cl. G06Q 10/06; G06F 11/36

(52) U.S. Cl. CPC G06Q 10/063; G06F 11/3684

(57) ABSTRACT

A system, a Computer-implemented method and an apparatus for the generation of automated, hybrid Test Suites for one or more Business Processes to measure one or more quality attributes of a system under test. A Processing module converts the Business Processes with tags into a Test-Centric Activity Diagram (TCAD) which is traversed by a Parsing module to identify one or more types of Nodes and corresponding Edges to generate one or more Lists that annotate the TCAD for an Analysis module which generates one or more Test Scenarios by representing the various paths through the Business Process under test in addition to Test Scenarios generated using other Tests. A Test Generator takes inputs from storage containing Test Data Models and the Test Scenarios generated by the Analysis module, to generate automated, hybrid Test Suites including, Test Cases, Test Data Placeholders, and Test Scripts.

### STATEMENT OF RELATED APPLICATIONS

This patent application claims priority on and the benefit of U.S. patent application Ser. No. 14/680,132 having a filing date of 7 Apr. 2015, which claims priority on and the benefit of U.S. Provisional Patent Application No. 61976522 having a filing date of 8 Apr. 2014.

### BACKGROUND OF THE INVENTION

### Technical Field

The present invention describes a system, method and apparatus for converting the business processes to test-centric activity diagrams to computationally generate automated test suites for various quality attributes.

### Prior Art

Automated test scenario generation has always been a challenge, a problem that the software testing industry has been looking to solve. Conventionally, it has been proven that over 30% of the effort in a typical software test life cycle is spent in authoring and maintaining test cases. Reduction of this effort will have a significant impact on the overall cost of the project and resource optimization.

The age-old graph theory has been “re-purposed” to derive test sequences (paths) from the diagram and additional “In-house” methods have been used to generate additional test cases.

U.S. Pat. No. 8,479,164 titled “Automated Test execution plan generation” describes a method to automatically generate test execution plans. Using this test execution plan generation tool, a set of user-configured testing parameters for a software application under test can be obtained. Using the user-configured test parameters and a predefined test execution plan data model, a test execution plan can be automatically generated. This tool consists of a computer program product stored on a physical medium where the plurality of user-configured testing parameters correlates with, at least one of the items contained in a predefined test execution plan data model associated with this tool.

U.S. Pat. No. 6,378,088 titled “Automated test generator” describes a process where the test generator generates tests by randomly traversing a description of the interface of the program being tested. It consists of a computer, and the test generator is executed by the computer. This represents an interface of the application program as a graph and it also automatically generates a test that exercises the application program. The tests generated contain randomly selected actions and randomly generated data. When these tests are executed, it randomly manipulates the program being tested.

U.S. Pat. No. 7,865,780 titled “Method for test case generation” describes a system, which provides randomly generated test cases for set of interfaces for a piece of software. The method comprises of a random test case number generator and a test case generator comprising of a parameter value generator. The parameter value generator assigns the parameter value for each interface based on the test case number. The method involves initializing a test case generator with parameter arrays with cardinality and a prime number for each individual parameter for each of the set of interfaces.

EP1926021 titled “Software test case generation” describes an apparatus, a computer program and a method for test case generation. The apparatus consists of a parser module, which analyses a source code into a code model, an analysis module, which utilizes the code model to parse a source code, in such a way that the execution paths can be determined. The system also consists of a user-interface module to visualize the possible execution paths in the source code and to allow the selection of the execution path from the user. A generation module is configured to generate a test case for testing of the selected execution path. These modules are configured to execute a computer program.

### BRIEF SUMMARY OF THE INVENTION

Path-based test conditions are well known in the art and refer to the method of testing where every possible path that the program could take, through the course of its execution, is tested. Test Cases in path-based coverage are prepared based on a logical complexity measure. Test sequences or cases can also be generated by expert systems, with the goal of increased automation. By summarizing domain knowledge based on a manual generation of test cases, the Test Cases and methods are encapsulated in an expert system that is used. (An expert system approach for generating test sequence for CTCS-3 train control system, Zhang Yong et. al., Fourth International Conference on Intelligent Control and Information Processing (IMP), 2013, IEEE.) Error-Based testing refers to using simple programmer error models and focus-directed methods for detecting the effects of errors. (Error-Based Software Testing and Analysis, Howden, 35th Annual Computer Software and Applications Conference Workshops (COMPSACW), 2011 IEEE.) Execution-Based testing refers to a method of inferring certain behavioral properties of the product based, in part, on the results of executing the software (product) in a known environment with selected inputs.

The present invention discloses a system, a computer-implemented method and an apparatus for the generation of automated, hybrid test suites for one or more Business Processes to measure one or more quality attributes of a system under test. Business Processes have tags associated with abstract computing steps that are quality attributes which the testing must achieve including Usability, Database Response, Non-mandatory Fields, Mandatory Fields, Network Failure, Popup Blocker, Multiple Iterations, etc. that is applied to the Business Process. The system and computer-implemented method of the present invention have a Processing module, a Parsing module, an Analysis module, and a Test Generator, a User-interface, one or more Business Processes with tags, and one or more Test Data Models. The Processing module comprises a Configurator and a Transformer wherein the Processing module takes in one or more Business Processes with tags, which are quality attributes that the testing must achieve, via a User-interface and converts it into a Test-Centric Activity Diagram (TCAD). The Parsing module traverses the TCAD to identify one or more types of Nodes and corresponding Edges to generate one or more Lists that annotate the TCAD for the Analysis module. The Analysis module comprises a Path Traverser and a Custom Traverser wherein the Analysis module generates one or more Test Scenarios by representing the various paths through the Business Process under test in addition to Test Scenarios generated using other Tests including Exception-Based, Event-Based, and Expert-System Based tests. The Test Generator takes one or more inputs from storage containing Test Data Models and the Test Scenarios generated by the Analysis module to arrive at an intermediate set of Test Condition Lists and finally automated, hybrid Test Suites including Test Cases, Test Data Placeholders, and Test Scripts are generated.

One or more Wireframes are used along with one or more Business Processes with tags as input to the Processing module. A Wireframe is a blueprint of the process along with a Test Data Model that is used to generate appropriate Test Suites at the Test Generator. The Configurator combines the Business Processes having tags with the Wireframes and passes this on to the Transformer. The Parsing module traverses the TCAD to identify one or more types of Nodes and corresponding Edges to generate one or more Lists that annotate the TCAD with Action, Pair, and Decision Lists. Nodes can be an Action Node that carries out a specific function, a Fork and Join Node that depicts the existence of Concurrent Test Conditions, and a Decision Node where a condition is being tested to decide the path of the Business Process. The Parsing module detects the Node ID, Incoming and Outgoing connections for the Action, Fork and Join and Decision Nodes, generating Edges and Lists while parsing. The Action Nodes alone go through an additional check for the presence of tags in order to create Action Objects that are tagged. An Action List is an array of interconnected actions which provides all possible ways of connecting to each action, also gives the List of Incoming and Outgoing actions. A Pair List is an array of interconnected pairs that provides all possible ways of connecting to each pair, also gives the List of Incoming and Outgoing pairs. A Decision List is an array of interconnected decisions that provides all possible ways of connecting to each decision, also gives the List of Incoming and Outgoing decisions.

### EXAMPLES

The present invention proposes a system, a computer-implemented method, and an apparatus for the examples of Ordering, Agent Sales, Sales Return from Customer, and Sales Return for Vendor.

### 1. Ordering

The present invention is applied to the Business Process of Ordering represented by the abstract steps of checking for the presence of the obsolete accounts, checking for the balance in the account, drawing funds, checking if there are sufficient funds, if there are sufficient funds, accepting order, sending to queue for processing, triggering acknowledgment to the customer, and ending process. If there is a shortage of funds, retrying the withdrawal of funds, gathering data if retry works, for the count of retry operation executed, for reaching a nominal failure point and verifying valid user. Rejecting order, if retrying withdrawal is not successful or if a user is not valid, rolling back order processing, triggering notification, and ending process. The Ordering process is assigned a plurality of tags to indicate the quality attributes which is being tested here including, ‘usability’, the presence of invalid users, and ‘fault injection’.

The Ordering process has a TCAD generated for it, annotated after passing through the Parsing module and Analysis module including inputs from the Test Data Models. Checking for the balance in the account, based on detailed Test Steps that verify the card number, verify the expiry date, and verify the CVV. Drawing funds based on detailed Test Steps that verify the correctness of obtained card details, verify availability of sufficient funds, and verify response code, to ensure if a user has sufficient funds. Accepting order based on detailed Test Steps that verify order number, verify item code, verify item quantity, verify details about coupons applied, verify transaction reference number, verify total amount, and verify the transactional amount. Sending the order to queue, based on detailed Test Steps that verify order number, verify shipment tracking number, verify shipment address, and verify transaction details. Triggering acknowledgment to the customer, simultaneously, based on detailed Test Steps that verify generated acknowledgment number, verify invoice number, and verify ordered item and quantity. Retrying withdrawal of funds, which does a ‘Usability’ checking, based on detailed Test Steps that verify order number, and verify card details. Rejecting the order, based on detailed Test Steps that verify the order number, verify reason for rejection, verify transaction reference number, and verify updating of order status. Rolling back order processing, based on detailed Test Steps that verify the order details, verify the order status, and verify that the order is not placed in such cases. Triggering notification to the customer, based on detailed Test Steps that verify the order number, verify the transaction reference number, verify the order status, verify reason for rejection, verify mail or mobile number, and verify user details. The Ordering process has Decision, Action, and Pair Lists generated after going through the Parsing module including.

The Ordering business process has hybrid, automated Test Suites generated including Test Cases, Test Data Placeholders for assigning values to the fields of order number, card number, expiry date, CVV number, item code, item quantity, coupon details, transaction amount, transaction reference number, shipment tracking number, shipment to address, shipment from address, acknowledgment number of the order, e-mail, invoice number, mobile number, order status, and reason for rejection, and Test Scripts.

### 2. Agent Sales

The present invention is applied to the Business Process of Agent Sales represented by the abstract steps of (i) Creating an expected sales order, (ii) Confirming and saving the sales order created, (iii) Approving the sales order, (iv) Receiving sales order as letter of credit (L/C), (v) Creating or updating L/C in sales order, (vi) If L/C not updated then proceeding to step xvi, (vii) Checking the credit limit, if exceeding proceeding to step xvi, (viii) Creating delivery if the credit limit has not exceeded, (ix) Saving the delivery number, (x) Creating transfer order and confirming, generating a pick list, (xi) Issuing of post goods (PGI) thus generating a delivery note and a packing list, (xii) Creating invoice, (xiii) Generating a commercial Invoice and printing, (xiv) Releasing for accounting, (xv) Checking accounting documents and ending process, and (xvi) Blocking delivery and ending process.

The Agent Sales has a TCAD generated for it, annotated after passing through the Parsing module and Analysis module including inputs from the Test Data Models. Creating an expected sales order based on detailed Test Steps that verifies sales document type, verifies sales organization, verifies distribution channel, verifies division, verifies sold to party, verifies ship to party, and verifies stock material. Confirming and saving the sales order created based on detailed Test Steps that verifies selling price to customer, verifies item availability, and validates receive the sales order details by letter of credit (L/C). Creating or updating a letter of credit (L/C) based on detailed Test Steps that verifies letter of credit document type, verifies sold to party, and ship to party, validates the financial document number after saving, and verifies the financial document number. Creating delivery if the credit limit has not exceeded based on detailed Test Steps that verifies warehouse number, verifies movement type, verifies material number, verifies quantity, verifies unit of measure, verifies plant or storage location, verifies storage unit type, and verifies movement data from data destination. Saving the delivery number based on detailed Test Steps that records the delivery number and validates the delivery number. Creating transfer order and confirming by generating a pick list, based on detailed Test Steps that verifies warehouse number, verifies movement type, verifies material number, verifies quantity, verifies unit of measure, verifies plant or storage location, verifies storage unit type, and verifies movement data. Creating invoice based on detailed Test Steps that verifies warehouse number, verifies movement type, verifies material number, verifies quantity, verifies unit of measure, verifies plant or storage location, verifies storage unit type, and verifies movement data.

The Agent Sales process has Decision, Action, and Pair Lists generated after going through the Parsing module. The Agent Sales has hybrid, automated Test Suites generated including Test Cases, Test Data Placeholders for assigning values to the fields of sales document type, sales organization, distribution channel, division, sold to party, ship to party, material, sales price, sales order number, shipping point, delivery date, warehouse number, movement type, material number, quantity, unit of measure, plant or storage location, storage unit type, from, destination, sales order, invoice number, accounting number, and financial year, and Test Scripts.

### 3. Sales Return from Customer

The present invention is applied to the Business Process of Sales Return from Customer represented by the abstract steps of (i) Checking for return from a customer, (ii) If returns received from the customer, then creating return order, (iii) Creating post goods receipt, (iv) Creating an inspection lot, (v) Inspecting for quality of returned goods, (vi) Recording inspection results, (vii) Checking for quality of goods, (viii) Generating an usage decision if goods quality is fine, (ix) Moving material to unrestricted stock, (x) Recording defect details if quality of goods are not fine, (xi) Creating a usage decision, (xii) Moving material to block stock and scrap, and (xiii) Creating a manual inspection lot if returns are not from customer and continuing steps v through xii as required.

The Return from Customer has a TCAD generated for it, annotated after passing through the Parsing module and Analysis module including inputs from the Test Data Models. Creating return order based on detailed Test Steps that verifies the order number, verifies shipping point, verifies date, and validates return delivery after saving. Creating post goods receipt based on detailed Test Steps that verifies T-code, verifies the delivery number, saves the transaction, and validates the transaction number. Creating an inspection lot based on detailed Test Steps that verifies the T-code, verifies material number, verifies plant, verifies inspection lot number, verifies inspection type, verifies inspection lot quantity, verifies start date, verifies inspection end date, verifies vendor, verifies purchasing organization, and verifies short text. Generating a usage decision if goods quality is fine based on detailed Test Steps that verifies the T-code, verifies inspection lot number, and verifies usage decision (UD) code, and creating a usage decision if goods quality is not fine, based on detailed Test Steps that, verifies T-code, verifies inspection lot number, and verifies UD code.

The Sales Return from Customer process has Decision, Action, and Pair Lists generated after going through the Parsing module. The Sales Return from Customer has hybrid, automated Test Suites generated including Test Cases, Test Data Placeholders for assigning values to the fields of order number, shipping point, date, delivery number, material number, plant, inspection lot number, inspection type, start date, inspection end date, vendor, purchasing organization, inspection lot number, and UD code, and Test Scripts.

### 4. Sales Return for Vendor

The present invention is applied to the Business Process of Sales Return for Vendor represented by the abstract steps of (i) Creating a return purchase order (PO), (ii) Checking approval of return PO, (iii) If not approved, either canceling or deleting PO generated, (iv) Creating a return outbound delivery, if the Return PO is approved, (v) Creating a return post goods issue (PGI), (vi) Verifying the return PGI, (vii) Rectifying the error in the return PGI to proceed further, if there is any error, (viii) Creating a gate pass if the return PGI is correct, and (viii) Creating a credit memo (MIRO).

The Sales Return for Vendor has a TCAD generated for it, annotated after passing through the Parsing module and Analysis module including inputs from the Test Data Models. Creating a return purchase order (PO) based on detailed Test Steps that verifies T-code and verifies document type. Creating a return outbound delivery based on detailed Test Steps that verifies the T-code, verifies the delivery number, and validates the return delivery number after saving. Creating a return post goods issue (PGI) based on detailed Test Steps that verifies the T-code, and verifies the delivery number, continue if no error. Creating a gate pass if the return PGI is correct based on detailed Test Steps that verifies the customized T-code for creating a delivery gate pass, verifies the delivery number, and verifies the gate pass transaction number once saved. Creating a credit memo (MIRO) based on detailed Test Steps that verifies the T-code in MIRO, verifies the return PO number, verifies financial year, and validates PO number in reference field.

The Sales Return from Customer process has Decision, Action, and Pair Lists generated after going through the Parsing module. The Sales Return from Customer has hybrid, automated Test Suites generated including Test Cases, Test Data Placeholders for assigning values to the fields of sales document type, account assignment category, item category, material number, quantity, plant, storage location, purchasing group, purchase requisition number, purchase order, warehouse number, storage type, and storage bin, and Test Scripts.

### BRIEF DESCRIPTION OF THE DRAWINGS

FIG. 1a illustrates the system of the present invention.

FIG. 1b illustrates a sample Wireframe.

FIG. 1c illustrates a Test-Centric Activity Diagram annotated with Action, Pair, and Decision Points.

FIG. 1d illustrates an example of Decision Lists, Action Lists, and Pair Lists.

FIG. 2a illustrates the overall method of the present invention.

FIG. 2b illustrates the step of Parsing in detail.

FIG. 2c illustrates the Test Generation in detail.

FIG. 3a illustrates the overall Business Process of an Ordering.

FIG. 3b illustrates annotated Business Process of the Ordering.

FIG. 3c illustrates the Decision Lists, Action Lists, and Pair Lists generated by the Parsing module for the Business Process of Ordering.

FIG. 3d illustrates the detailed Test Steps for each activity in the Business Process of Ordering.

FIG. 3e illustrates the Test Data Placeholder generated by the system for the Business Process of Ordering.

FIG. 3f illustrates a sample Test Script generated by the system for the Business Process of Ordering.

FIG. 4a illustrates a Test-Centric Activity Diagram for the Business Process of Agent Sales.

FIG. 4b illustrates the Decision Lists, Action Lists, and Pair Lists generated by the Parsing module for the Business Process of Agent Sales.

FIG. 4c illustrates the detailed Test Steps for each activity for the Business Process of Agent Sales.

FIG. 4d illustrates the Test Data Placeholder generated by the system for the Business Process of Agent Sales.

FIG. 5a illustrates a Test-Centric Activity Diagram for the Business Process of Sales Return from Customer.

FIG. 5b illustrates the Decision Lists, Action Lists, and Pair Lists generated by the Parsing module for the Business Process of Sales Return from Customer.

FIG. 5c illustrates the detailed Test Steps for each activity for the Business Process of Sales Return from Customer.

FIG. 5d illustrates the Test Data Placeholder generated by the system for the Business Process of Sales Return from Customer.

FIG. 6a illustrates a Test-Centric Activity Diagram for the Business Process Sales Return for Vendor.

FIG. 6b illustrates the Decision Lists, Action Lists, and Pair Lists generated by the Parsing module for the Business Process of Sales Return for Vendor.

FIG. 6c illustrates the detailed Test Steps for each activity for the Business Process of Sales Return for Vendor.

FIG. 6d illustrates the Test Data Placeholder generated by the system for the Business Process of Sales Return for Vendor.

FIG. 7 illustrates a representative apparatus of the present invention.

### DETAILED DESCRIPTION OF PREFERRED EMBODIMENTS

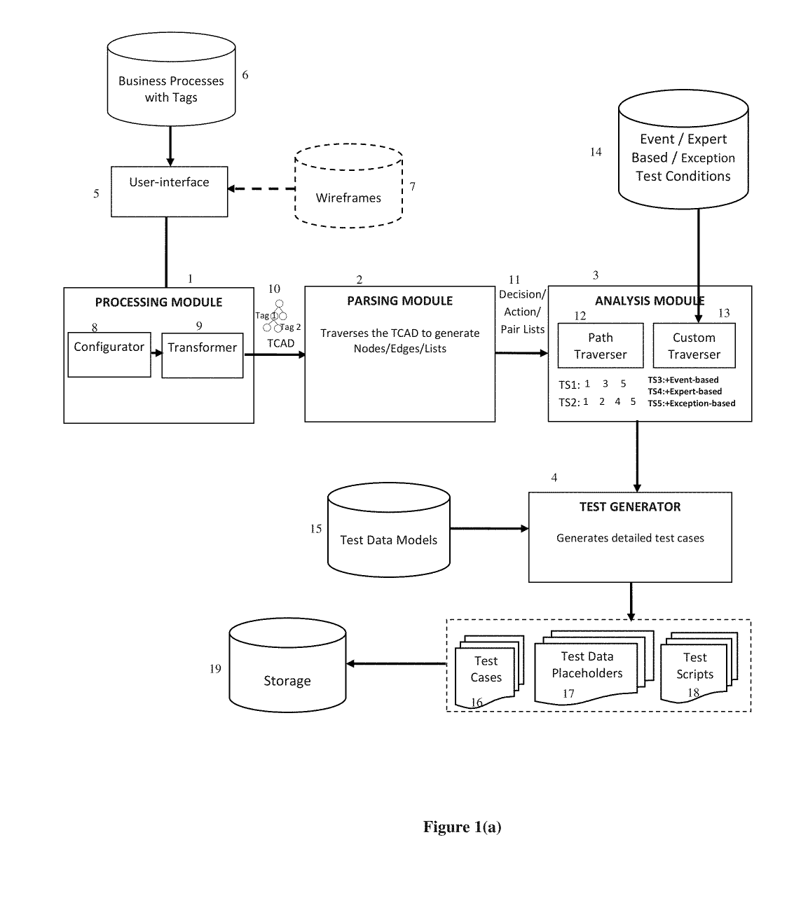

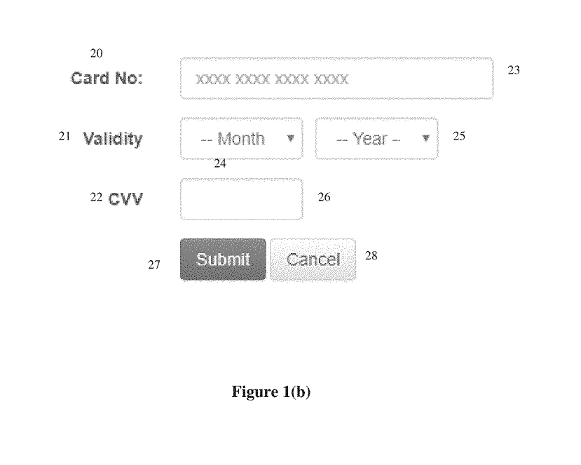

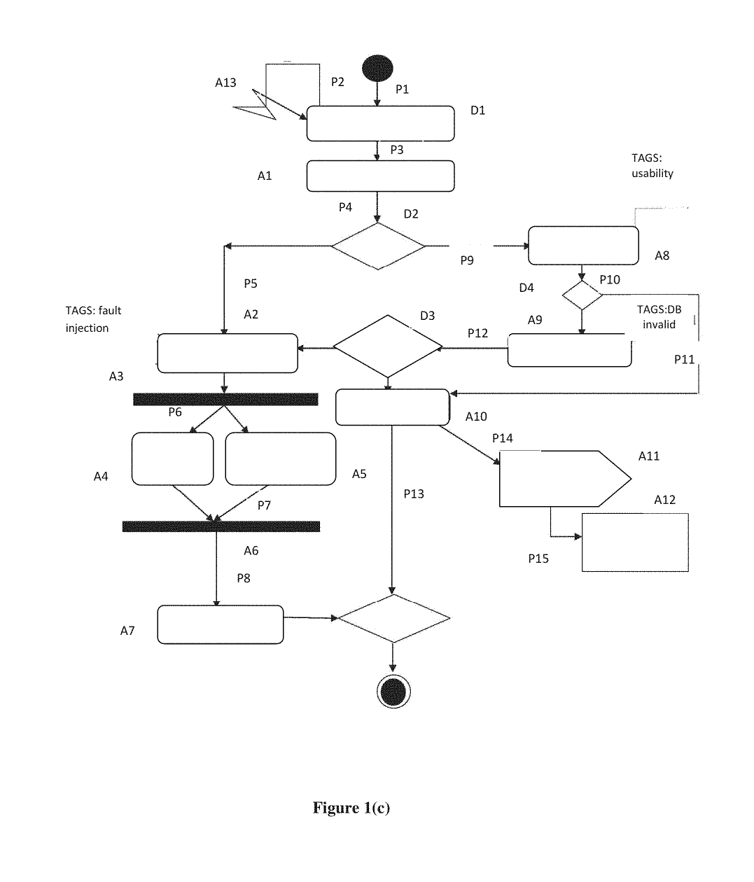

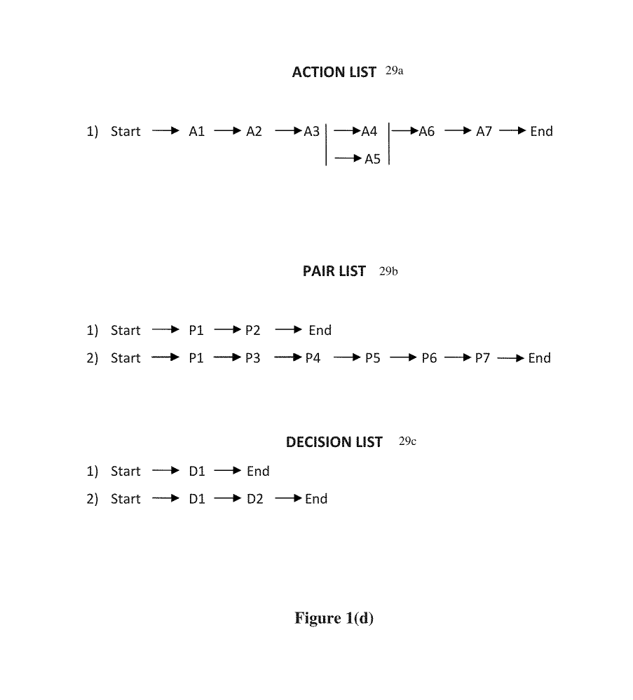

FIG. 1a describes the system of the present invention. The main modules are a Processing module 1, a Parsing module 2, an Analysis module 3 and a Test Generator 4. Business Processes with certain tags 6 are taken from storage via a User-interface 5 and fed to the Processing module 1. Optionally certain images stored in a Wireframes database are also taken along with the Business Processes to improve the representation of the Business Process. The Processing module 1 has two abstract modules, a Configurator 8 and a Transformer 9. The Configurator 8 combines the Business Process with tags along with the Wireframes 7 and sends this output to the Transformer 9, which then converts that into a Test-Centric Activity Diagram (TCAD) 10 that represent the Business Process as a graph with tags which are placed on certain Nodes of the graph. Tags can be described as quality attributes that the testing must achieve, for example, Usability, Database Response, Non-mandatory Fields, Mandatory Fields, Network Failure, Popup Blocker, Multiple Iterations, etc.

A TCAD is a focused representation of the Business Process created with the various tests that should be performed at the various logical points within the Business Process. For example, if there is a ‘Retry’ button within a Web page, a tag that could be associated with it is the tag of ‘Usability’. So that needs to be tested when the Business Process is run through the testing phase. Therefore the TCAD 10 is the cornerstone of the representation that this invention works with. The Parsing module 2 takes the TCAD 10 and traverses it to generate Nodes, Edges, and Lists. The Nodes within the TCAD 10 could be Decision Nodes, Fork and Join Nodes, or Action Nodes. These are the three types of Nodes within a TCAD 10. The Edges are the connectors between the Nodes. The Lists refer to certain attributes that are represented in List form, for example, the decisions that might affect the flow of the Business Process. The Decision, Action, and Pair Lists 11 that are generated by the Parsing module 2 are sent to the Analysis module 3, which has two abstract modules called the Path Traverser 12 and the Custom Traverser 13. The Path Traverser generates Test Scenarios for the coverage of various logical paths through the Business Process which need to be tested. The output of the Analysis module is a plurality of Test Scenarios. For example, the Path Traverser 12 might generate two valid Test Scenarios for a TCAD, Test Scenario 1 (TS1) where the Nodes 1, 3, 5 need to be traversed and Test Scenario 2 (TS2) where the Nodes 1, 3, 4, 5 required to be traversed in order to cover the entire Business Process that is being executed. The Custom Traverser 13 on the other hand takes inputs from storage having Event-Based, Expert-System Based, Exception-Based Test Conditions 14 which are used to construct further Test Scenarios based on the different types of testing methodologies that are known. The Test Generator 4 takes the Test Scenarios from the Analysis module 3 and converts them into Test Condition Lists. The Test Generator 4 further uses inputs from a Test Data Model storage 19 that might work in lieu with the Wireframes 7. Since the Wireframes 7 is not mandatory, the Test Data Model 15 acts as a second set of clues into how the tests might be generated for a given Business Process. The Test Generator 4 goes on to generate the Test Cases 16, Test Data Placeholders 17, Test Scripts 18 that can be used to test the Business Process that we are interested in, and this is stored in a local or a remote storage 19 in a plurality of formats including Excel, text files, etc.

FIG. 1b describes a sample Wireframe 7 which is a Page schematic or a blueprint of a Business Process “Ordering” that describes the fields card number 20, validity 21, CVV 22. The field card number 20 takes sixteen-digit credit or debit card number input 23, the field validity 21 takes the month 24 and year 25 until which the corresponding credit or debit card is valid. The CVV 22 field takes the CVV number 26 of a given credit or debit card. Once the inputs are included in the corresponding fields 23, 24, 25, 26, can be submitted by selecting a ‘submit’ button 27. If the fed details are to be ignored for some reason, then a cancel button 28 helps to cancel the submission.

FIG. 1c shows the TCAD 10 after it is being annotated by the Parsing module 2 to identify the Action, Pair, and Decision Points annotated as the A-series of the Nodes, the P-series, and the D-series as labeled in this Figure. Fundamentally, the Parsing module 2 takes the TCAD 10 and identifies which Nodes are Action Nodes, Decision Nodes or Fork and Join Nodes, and also sends out a List of Decision, Action and Pair Lists.

FIG. 1d shows an example Decision List, Action List, and Pair List 11. An Action List 29a is an array of interconnected actions that provides all possible ways of connecting to each action, also gives the List of Incoming and Outgoing actions. A Pair List 29b is an array of interconnected pairs that provides all possible ways of connecting to each pair, also gives the List of Incoming and Outgoing pairs. A Decision List 29c is an array of interconnected decisions that provides all possible ways of connecting to each decision, also gives the List of Incoming and Outgoing decisions.

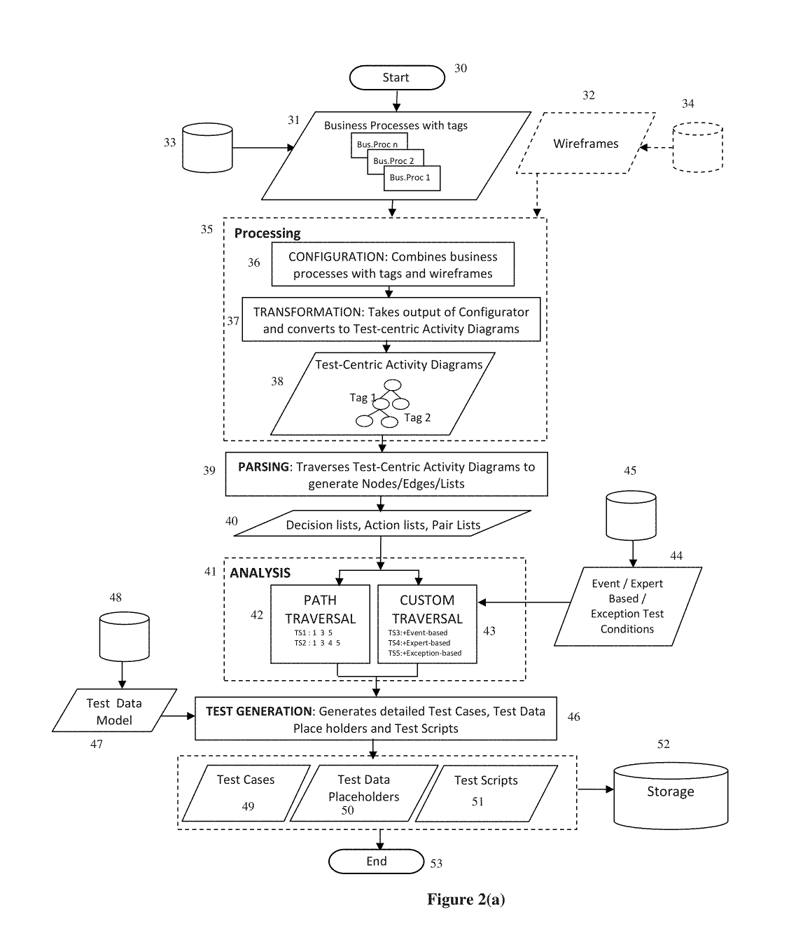

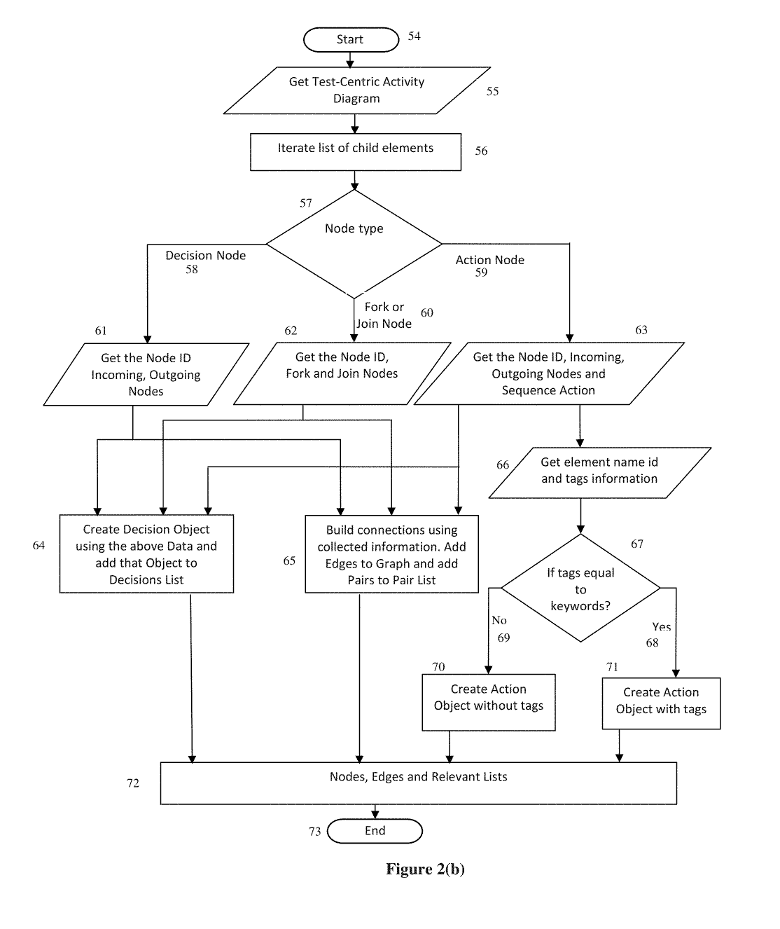

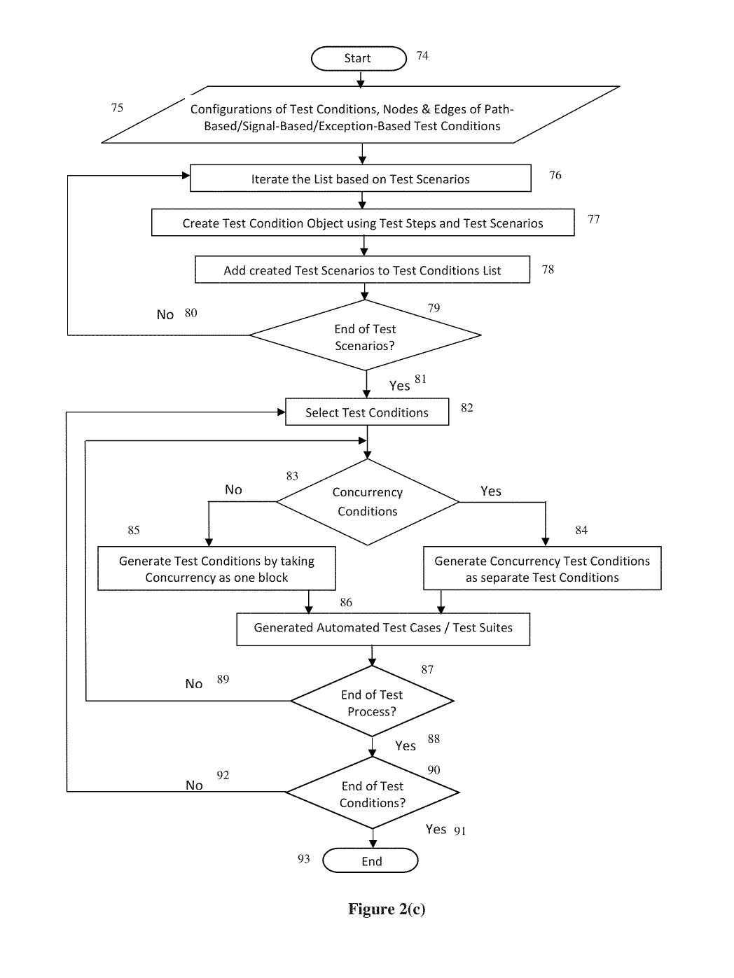

FIG. 2a describes the overall method of the present invention. The method starts 30 by taking in Business Processes that are annotated with tags 31 and optionally from Wireframes 32 from two different storage units 33, 34 through a User-interface, passing via a Computer into a step of Processing 35 that has a Configuration 36 for combining the Business Process with tags 31 and the Wireframes 32. A Transformation step 37 taking the output from the Configuration 36 and converting them into TCADs 38 which are a graph-based representation of the Business Process with appropriate tags 31 applied at the appropriate Nodes. The Parsing 39 traverses the TCAD 38 generating Nodes, Edges and Lists. The output of the Parsing step is a set of Decision Lists, Action Lists, and Pair Lists 40. In the Analysis step, 41 that comprise a Path Traversal 42 and a Custom Traversal 43 where a Path Traversal 42 receives various Path-Based tests that can represent the Business Process generating what are Test Scenarios. For example, the Path Traversal 42 generates Test Scenarios TS1 and TS2, wherein Test Scenario TS1 shows traversing of the TCAD 38 via Nodes 1, 3 and 5. Test Scenario TS2 for the Path Traversal 42 shows traversing of the TCAD via Nodes 1, 3, 4 and 5. Similarly, the Custom Traversal 43 taking inputs from external storage 45 for Event-Based, Expert-System Based and Exception-Based Test Conditions 44 and the generating Test Scenarios TS3, TS4, and TS5 which then goes on creating hybrid set of Test Condition Lists which are fed to the Test Generation 46. The Test Generator 46 generating Test Cases 49, Test Data Placeholders 50, Test Scripts 51 using these Test Condition Lists in conjunction with the Test Data Model 47 taken from Storage 48, which is used in conjunction or along with Wireframes 32 should they not exist at the beginning. Thus, the final outputs are the Test Cases 49, Test Data Placeholders 50, and Test Scripts 51 and are stored in a local or a remote storage 52 in a plurality of formats including Excel, text files, etc, and the process ends 53.

FIG. 2b describes the step of Parsing in greater detail wherein the Parsing starts 54 by getting the TCAD 55, which can be a Document Object of the XMI file. It then goes on to iterate the List of child elements 56 within the XMI file of the Business Process in the TCAD for identifying which Node type 57 it is dealing with. There are three types of Nodes, a Decision Node 58, a Fork or Join Node 60 and an Action Node 59. In each case the Node ID and the Incoming and Outgoing Nodes are obtained 61, 62, 63 during parsing, which also goes on to create a Decision Object using the data, to add that Object to the Decision List 64 and also builds connections using collected information, adding the Edges to the graph and adding Pairs to the Pair List 65. In the case of an Action Node there is an extra step over and above creating Decision Objects and building connects which is getting the element name id and the tag information 66, checking if the tags are equal to keywords 67, if so 68 creating an Action Object with tags 71 and if there are no tags equal to keywords 69 then creating an Action Object without tags 70. Tags are quality attributes that the testing must achieve, for example, Usability, Database Response, Non-mandatory Fields, Mandatory Fields, Network Failure, Popup Blocker, Multiple Iterations, etc. The output of the Parsing is the List of Nodes, Edges and relevant Lists including Decision, Pair, and Action Lists 72 and the parsing ends 73.

FIG. 2c describes Test Generation in more detail, which starts 74 with taking configurations of Test conditions, Nodes, Edges and Path-Based, Event-Based, or Exception-Based Test Conditions 75. Iterating through the Test Scenarios 76 generated by the Analysis step. Creating Test Condition Object using the Test Steps and Test Scenarios 77. Adding the created Test Scenario to the Test Conditions Lists 78. Checking for the end of Test Scenarios 79, if the Test Scenarios have ended 81 then selecting the Test Conditions 82, else 80 continue iterating 76. If there is a Concurrency Condition 83 then generating the Concurrency Test Conditions as separate Test Condition 84. If there are no Concurrency conditions then generating the Test Conditions by taking the Concurrency as one block 85. These two steps then go on to generate Automated Test Cases or Test Suites or Test Data Placeholders 86 then checking for the end of that Test Process 87 if not 89 going back to the step prior to the check for Concurrency Conditions 83. If it is the end of the Test process 88 then checking for end of Test Conditions 90 as well if not 92 going back for selecting another Test Condition 82 to process. On reaching end of the Test process 88 and the Test Conditions had ended 91 as well then the Test generation ends 93.

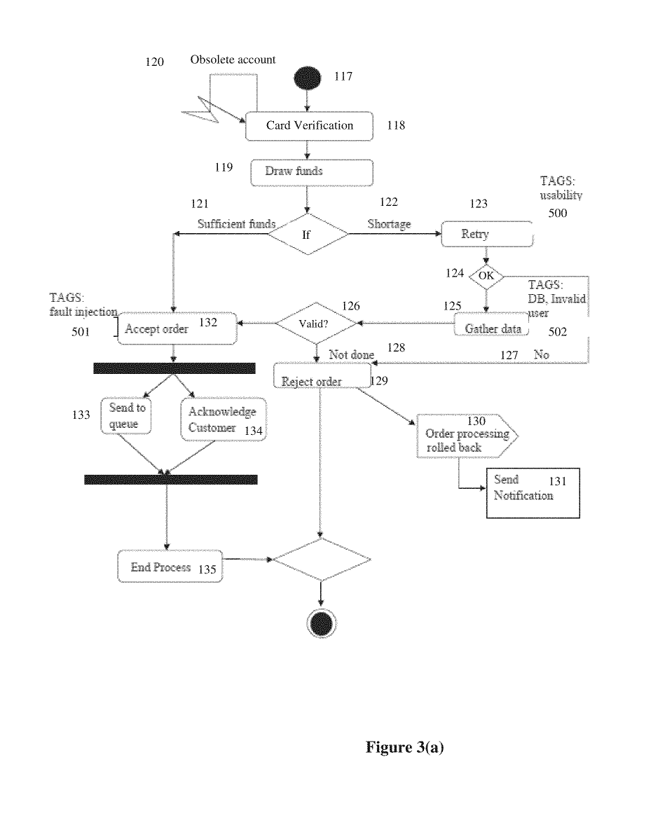

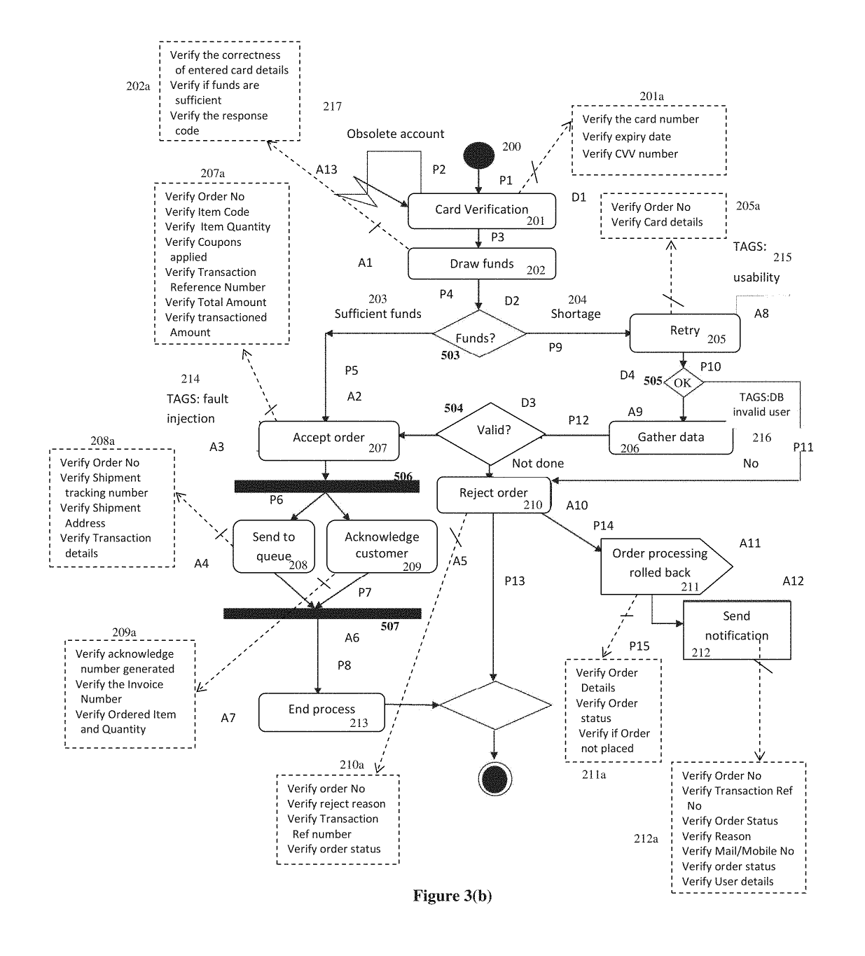

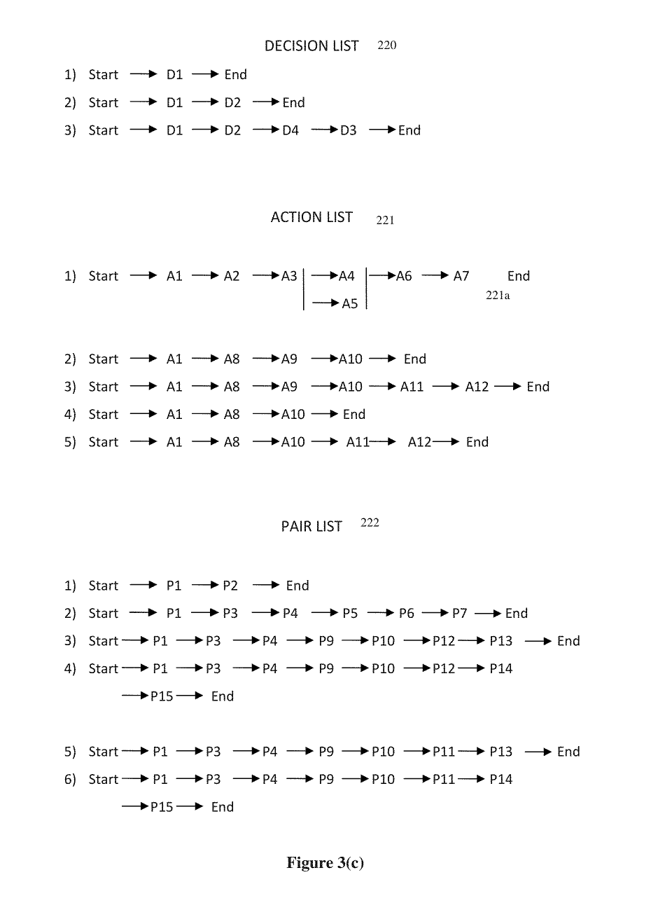

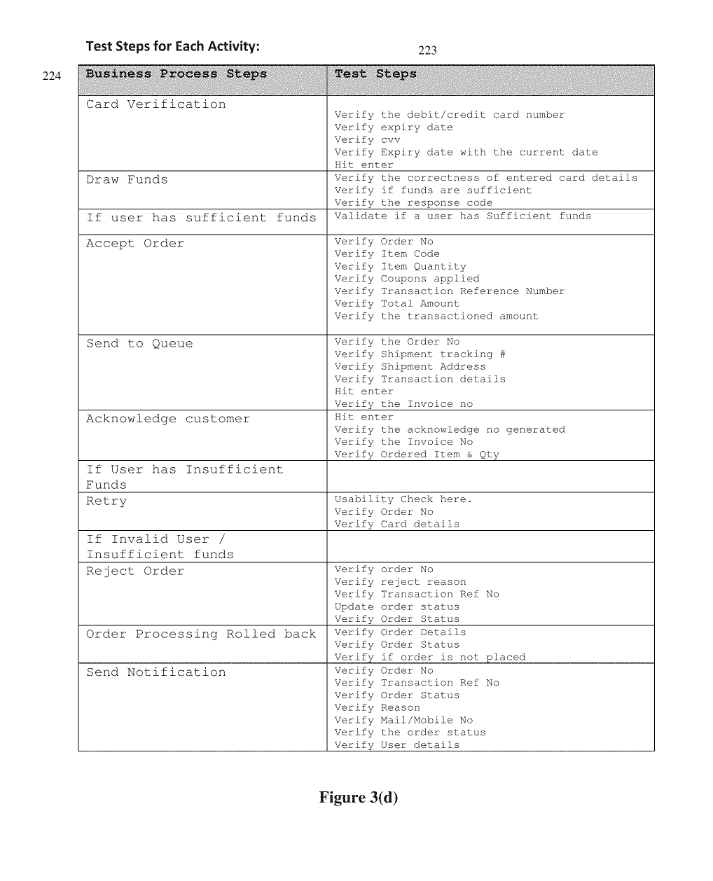

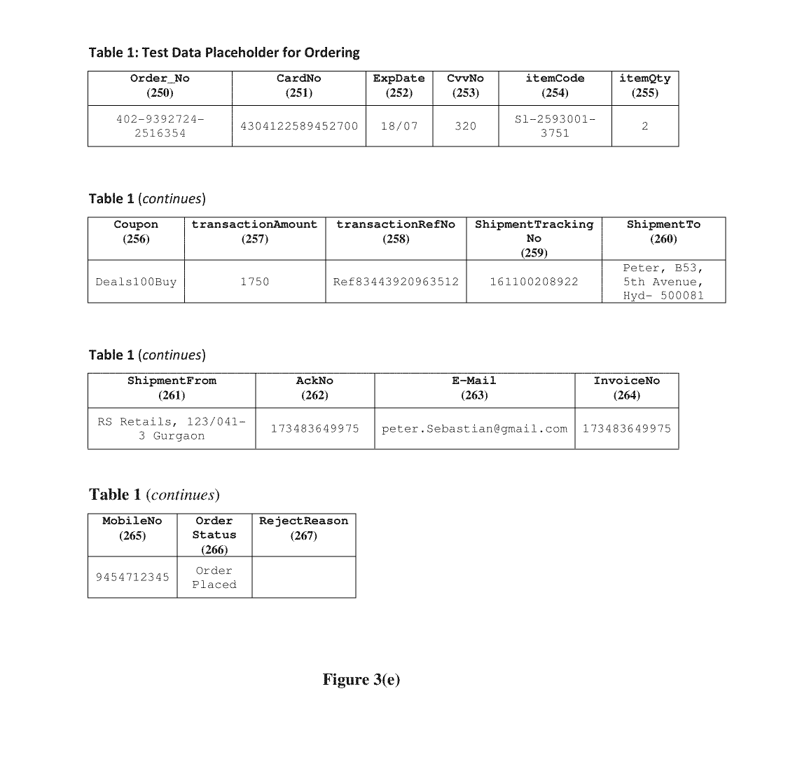

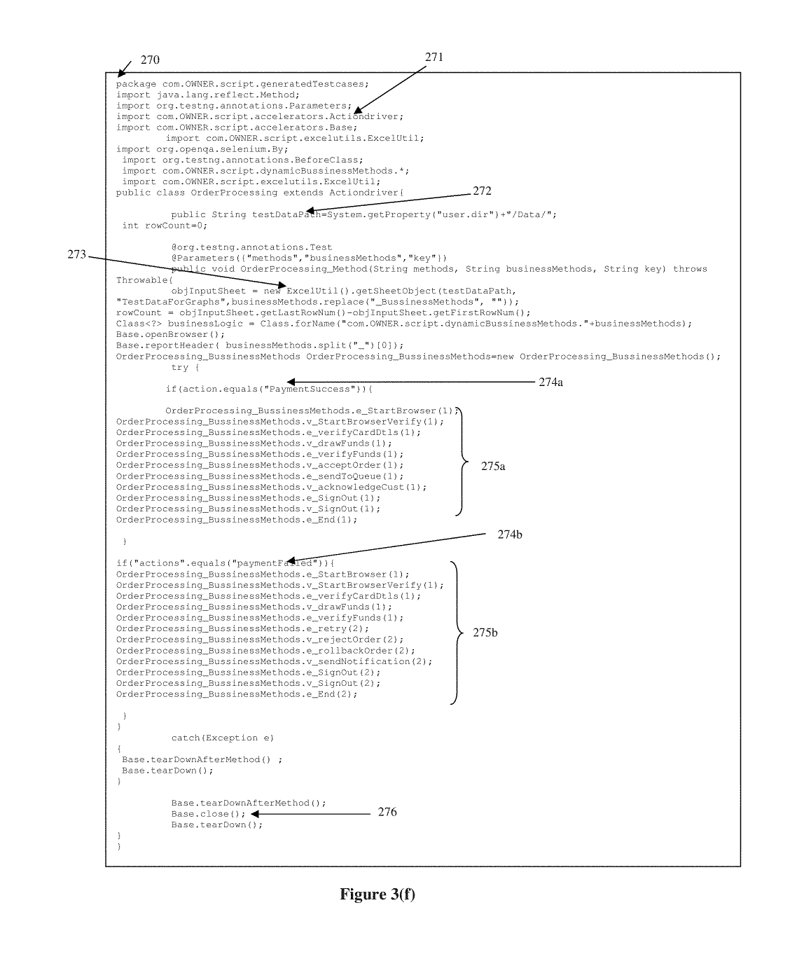

FIGS. 3a to 3f describes the various stages of one example of the present system which in ‘Ordering’, which is a Business Process used on several e-commerce Web sites for placing various orders.

FIG. 3a describes the overall Business Process of Ordering that is represented by the abstract logical steps performed in order to get from start 117 to finish 135 of an Ordering Process. For example, Ordering checks for the presence of the Obsolete accounts 120, checks for the balance in the account 118, goes on to draw funds 119, then goes on to check if there are sufficient funds 121, if there is a shortage of funds 122 retries 123 the withdrawal of funds 119, gathers data 125 in order to understand how many times the retry operation 124 was executed in order to reach a nominal failure point 128. If there are sufficient funds 121, the order is accepted 132, it then goes a queue 133 and also acknowledges a customer 134 because the same customer might be placing multiple orders and then ends the process 135. If the ordering is not done or the ordering went through the retry process 123 after data gathering the process goes through either the rejection 129 if the user is not valid 128 or the acceptance of an order 132 for valid user 126. The acceptance of the order 132 has been discussed, but in the rejection of the order 129 one can either roll-back the process 130 and send the notification 131 to the system and the customer or one can just end the process 135. This is the overall process. A couple of tags have been shown to indicate the quality attributes that are being tested here including ‘usability’ 500 and the presence of invalid users 502 and also ‘fault injection’ 501, for example, if the system fails at the stage of the order being accepted 132. For example, if the website does not finish its transaction with the secured server which is processing the payment then this is shown in Node 500, ‘Usability’ is basically whether the retry operation 123 is user-friendly. The invalid user tag 502 is checked to see whether the process is gathering data 125 on legitimate customer. These are all quality attributes that the system checks in our present invention and FIG. 3a just shows the overall Business Process with abstract steps including the tags.

FIG. 3b shows the TCAD for Ordering Process annotated after passing through the Parsing module and Analysis module by showing various Test Steps shown in dashed boxes 201a, 202a, 205a, 207a, 208a, 209a, 210a, 211a, 212a. Once the TCAD 10 passes through the Parsing module 2, the Action, Pair, and Decision Points are also annotated in order to assist the Test Generator in generating the Test Cases correctly.

The process starts 200 by verification of card 201 in which details such as a debit or credit card number, expiry date of the card, CVV number of the card, 201a, are verified. The expiry date is then validated with the current date by the system. If the expiry date is earlier than the current date, the account is marked as obsolete account 216 by the system and the process terminates. The funds are drawn 202 during which the correctness of obtained card details, availability of sufficient funds and response code are verified 202a and a decision is made 503 to ensure if a user has sufficient funds. On availability of sufficient balance 203 in the user's account, the funds are drawn after verifying 503, and for any shortage of funds 204, the system allows a retry 205 which does ‘Usability’ check. The order number and card details 205a are also verified consecutively. While retrying process 205 data is gathered 206 if retry works 505 on numbers of times the retry is done to check validity of the user 504. If there is a shortage of funds 204 or the user is invalid 216, the order gets rejected 210 during which the order number, reason for rejection, transaction reference number are verified, and order status is updated 210a. Further, the order processing is rolled back 211 by verifying order details and order status, also confirms that the order is not placed 211a in such cases. A notification is triggered to the client 212 after verifying the order details, transaction reference number, order status, reason for rejection, mail or mobile number and also, user details are verified 212a.

On sufficient availability of funds 203, the order gets accepted 207 by validating order number, item code, item quantity, details about coupons applied, transaction reference number and total amount 207a. The transacted amount is verified against the total order value to proceed further. The order is sent to queue 208 by verifying details such as order number, shipment tracking number, shipment address, and transaction details 208a, in which the invoice number is also confirmed. Simultaneously, an acknowledgment is triggered to the customer 209 after validating the generated acknowledgment number, order number, email and mobile number, and transaction details 209a. Before ending the process 213 the invoice number, ordered item and quantity are validated.

In this case, different types of Test Cases are generated namely, Exception-Based Test Case, Path-Based Test Case, Tag-Based Test Case and Event-Based Test Case. The ‘order processing’ scenario includes the Action types or Action Nodes “card verification’ 201, ‘draw funds’ 202, ‘accept order’ 207, ‘retry’ 205, ‘gather data’ 206, ‘reject order’ 210 and ‘end process’ 213. The tag ‘usability’ 215 is used for ‘retry’ action 205, the tag ‘fault injection’ 214 is used for ‘accept order’ 207, the tags ‘database’, ‘invalid values’ 216 are used for the action ‘gather data’ 206. The Decision Nodes are 503, 504, 505, Fork Node is 506, Join Node is 507 and all Edges are of Action type.

FIG. 3c shows the Decision Lists, Action Lists, and Pair Lists 11 generated by the Parsing module 2 for the Business Process of Ordering. An Action List 221 is an array of interconnected actions that provides all possible ways of connecting to each action, also gives the List of Incoming and Outgoing actions. A Pair List 222 is an array of interconnected pairs that provides all possible ways of connecting to each pair, also gives the List of Incoming and Outgoing pairs. A Decision List 220 is an array of interconnected decisions that provides all possible ways of connecting to each decision, also gives the List of Incoming and Outgoing decisions.

In the Decision Lists 220 are
Validate Card details if not valid, consider as Obsolete account and end.
Verify card details and if card details are valid, then draw funds. If funds are sufficient then accept order, send to queue, and acknowledge customer.
Verify card details and retry if there is shortage of funds. If sufficient funds found, accept the order and send to queue along with a user acknowledgement.
Validate card details and if valid, retry for funds and, further if the user is not valid, reject the order and end.

In the Action Lists 221 are
If valid card details then draw funds, if funds are sufficient then accept order, send to queue, and acknowledge customer.
If valid card details then draw funds. If there is a shortage of funds, retry by verifying order number and card details. If valid user then gather data and accept order. Send the order to queue and acknowledge the customer.
If valid card details, draw funds if funds are shortage, retry by verifying order number, and card details. If not a valid user, then gather data and reject order, and order processing is rolled back by a sending notification.
If valid card details, draw funds if funds are shortage, retry by verifying order number, and card details. If incorrect card detail or not valid reject order.

In the Action Lists 222 are
Validate card details and if it is an obsolete account then process is terminates.
Validate card details and if it is not an obsolete account then draw funds. If funds are sufficient, accept order, send to queue or acknowledge customer.
Validate card details and if it is not an obsolete account then draw funds. If funds are sufficient or shortage, check if a valid user and gather data. If order is not done reject order.
Validate card details and if it is not an obsolete account then draw funds. If funds are sufficient or shortage, check if a valid user and gather data. If order is not done reject order and order processing rolled back by sending notification.
Validate card details and if it is not an obsolete account then draw funds. If funds are sufficient or shortage, check if not a valid user then reject order.
Validate card details and if it is not an obsolete account then draw funds. If funds are sufficient or shortage, check if not a valid user then reject order and order processing rolled back by sending notification.

FIG. 3d shows the detailed Test Steps 223 for each activity in the Business Process 224 as generated at the Test Generator 4 by traversing through the TCAD in FIG. 3b. The process in the TCAD 201a, 202a, 207a, 208a, 209a, 205a, 210a, 211a, 212a forms the Test Steps 223 in the same order for the corresponding Business Process steps which are, card verification 201, draw funds 202, accept order 207, send to queue 208, acknowledge customer 209, retry 205, reject Order 210, order processing rolled back 211, send notification 212. For example, the Test Steps of card verification 201 comprise verify the debit or credit card number, verify expiry date, verify CVV, verify expiry date with the current date and Hit enter. The Test Steps for ‘draw funds’ 202 includes, verify the correctness of entered card details, verify if funds are sufficient and verify the response code, and those for ‘if a user has sufficient funds’ 203 is validate if a user has sufficient funds.

FIG. 3e shows the Test Data Placeholders 17 that are generated which is actual Test Data used to conduct or execute the Tests, and these are also a part of the output of our present system to generate these Test Data Placeholders 17. For example, for Order Processing, sample Test Data Placeholders 17 includes assigning values to the fields of order number 250, card number 251, expiry date 252, CVV number 253, item code 254, item quantity 255, coupon details 256, transaction amount 257, transaction reference number 258, shipment tracking number 259, shipment to address 260, shipment from address 261, acknowledgment number of the order 262, e-mail 263, invoice number 264, mobile number 265, order status 266, and reason for rejection 267.

FIG. 3f shows a sample Test Script 18 generated by the Test Generator 4 that manages the Business Process using a Keyword Framework as a base. A Package Name 270 is a label of the package in which this Test Script is generated. Import statements 271 include location of the user-defined functions or libraries or labels or classes which are used in this Test Script. Test Data Path 272 refer to the Test Data Placeholder 17 generated out of the Test Generator 4. Using Excel Utility files 273, ‘Order Processing Method’ retrieves the data by traversing through every cell of the excel files. Based on ‘payment success’ 274a or ‘payment failed’ 274b actions, a series of actions or user-defined functions 275a, 275b are executed. For example, for ‘payment success’ criteria 274a, the series of functions performed are start browser, verify card details, draw funds, verify funds, accept order, send to queue, acknowledge customer, and sign out 275a. Finally, the browsers are closed 276 and the script execution is called off.

The Lists generated are Decision Lists D1, D2, D3, D4, Action Lists A1, A2, A3, A4, A5, A6, A7, A8, A9, A10, A11, A2, A13, and Pair Lists P1, P2, P3, P4, P5, P6, P7, P8, P9, P10, P11, P12, P13, P14, P15. For the Business Process of Ordering, the invention generated 10 Test Cases, which includes four Test Cases, four Tag-Based or Experience-Based Test Cases, one Experience-Based Test Case, and one Experience-Based Test Case.

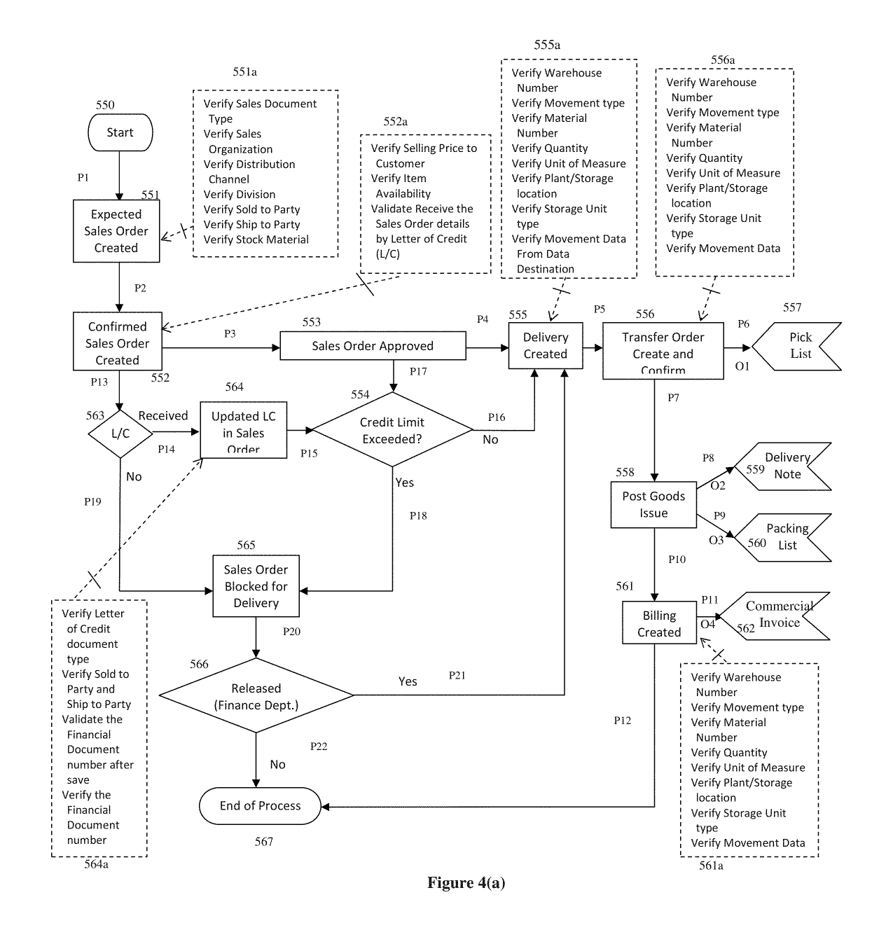

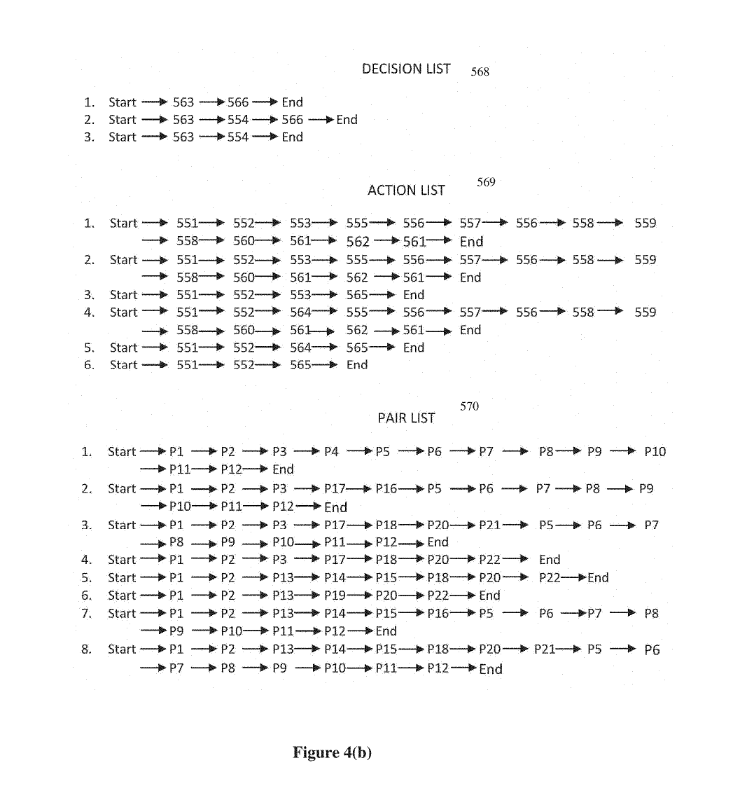

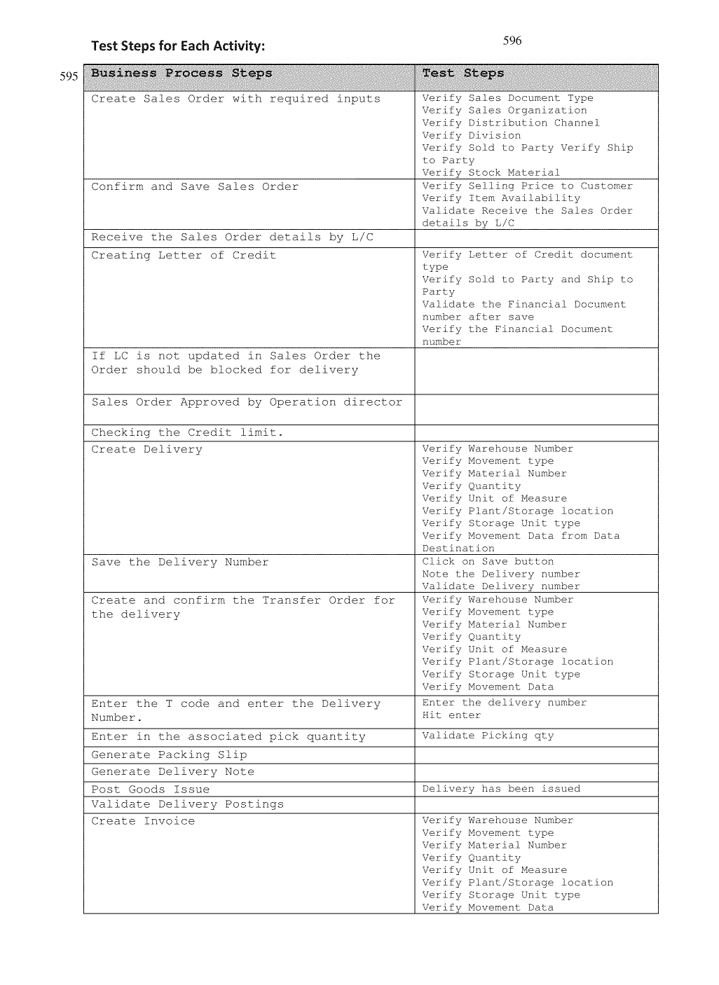

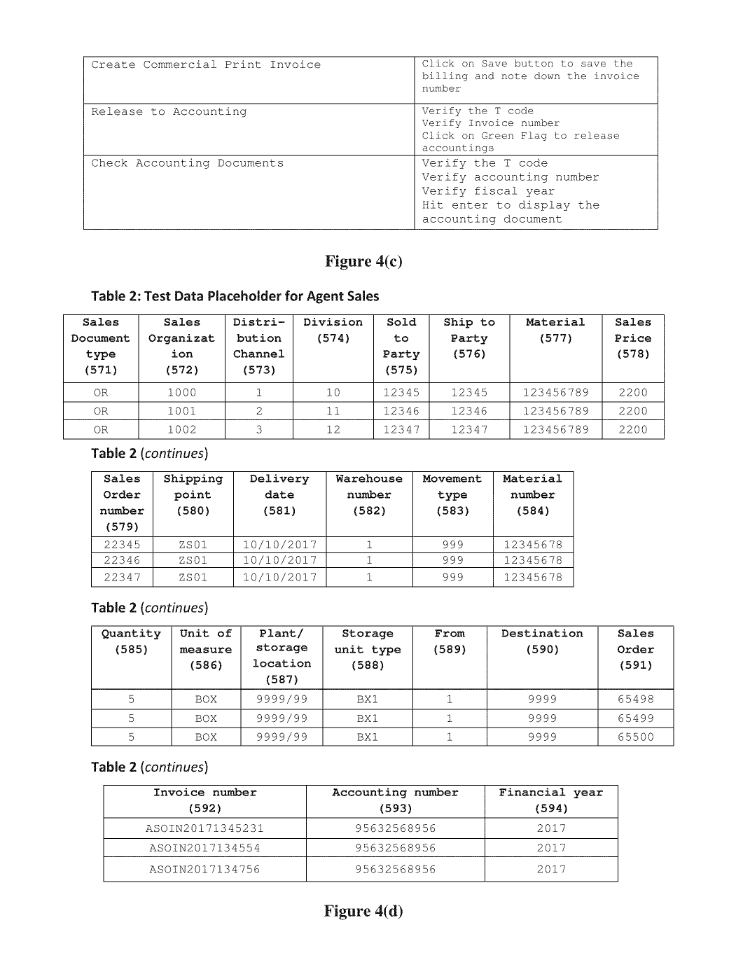

FIG. 4a shows the TCAD for the Business Process of Agent Sales annotated after passing through the Parsing module and Analysis module by showing various Test Steps showed in dashed boxes 551a, 552a, 555a, 556a, 561a, 564a. Once the TCAD 10 passes through the Parsing module 2, the Action, Pair, and Decision Points are also annotated in order to assist the Test Generator in generating the Test Cases correctly.

The process starts 550 by creating an expected sales order 551 that verifies sales document type, sales organization, distribution channel, division, sold to party, ship to party, and stock material 551a. The sales order is confirmed and saved 552, by verifying selling price for the customer, availability of ordered item, and validating the received sales order by Letter of Credit (L/C) 552a. If the item is available 552a, the sales order number is generated and said sales order is confirmed 552, saved, and approved 553. Once the sales order is approved 553, the credit limit is checked 554, if not exceeding the limit the delivery is created 555, by verifying the warehouse number, movement type, material number, order quantity, unit of measure, plant or storage location, storage unit type and movement data from destination data 555a. The delivery number is saved by clicking on ‘Save’ button, further recorded and validated. The transfer order is generated and confirmed 556, for the delivery created by verifying the values for warehouse number, movement type, material number, quantity, unit of measure, plant or storage location, storage unit type, and movement data 556a, during which, a pick list is generated 557. Once the delivery has been issued a post goods issue (PGI) 558 is created by generating a packing list 560 and a delivery note 559. Finally, a bill is created 561 as a commercial invoice 562 by verifying details such as, warehouse number, movement type, material number, quantity, unit of measure, plant or storage location, storage unit type, and movement data 561a. The generated commercial invoice 562 is saved by selecting ‘Save’ button and the invoice number is recorded in the system. The invoice is released for accounting that verifies the transaction code (T-code), invoice number and clicking on a ‘Green Flag. The account documents are checked for T-code, accounting number, fiscal year and an ‘enter’ button is pressed for displaying the accounting document.

The sales order details if received as the letter of credit (L/C) 563, is updated in the sales order 564, by verifying the letter of credit document type, sold to party, ship to party, and the financial document number is saved, recorded, and validated for the said financial document number, once recorded in the system 564a. If the credit limit has not exceeded 554, the delivery is created 555, and the same process is followed after the creation of the delivery 555 as explained above. But, if the credit limit exceeds 554, and if the confirmed sales order created is not received as an L/C, then the sales order is blocked for the delivery 565. If the Finance department releases the accounting 566 that was blocked for delivery, then the delivery is created 555, else the process ends 567.

Creating expected sales order 551, confirmed sales order created 552, sales order approved 553, updating L/C in sales order 564, blocking sales order for delivery 565, and creating delivery 555 are Activity Nodes. Decision Nodes are verifying letter of credit 563, checking credit limit 554, and release of sales order 566. All Edges are Activity Edges except the four Object Edges, O1, O2, O3, O4. The other Activity Nodes are creating Transfer order and confirming 556, post goods issue 558, and creating billing 561. The method resulted in the generation of 14 Test Cases which, includes ten Path-Based Test Cases, three Error-Based Test Cases, and one Event-Based Test Case. P1, P2, P3, P4, P5, P6, P7, P8, P9, P10, P11, P12, P13, P14, P15, P16, P17, P18, P19, P20, P21, P22 are the Pair points annotated.

FIG. 4b shows the Decision Lists, Action Lists, and Pair Lists 11 generated by the Parsing module 2 for the Business Process of Agent Sales which includes a Decision List 568, Action List 569, and Pair List 570 wherein:

In the Decision List 568 are
If letter of credit (L/C) is not received, then sales order is blocked for delivery, and sent to release (Finance department). If it does not approve then the process ends.
If L/C is received, then updated L/C in sales order. If credit limit is exceeded then sales order is blocked for delivery and sent to release (Finance department). If it does not approve then the process ends.
If L/C is received, then update L/C in sales order if credit limit is not exceeded, sent to further process.

In the Action List 569 are
Expected sales order created, and created sales order is confirmed. Sales order is approved, and the delivery created. Order is transferred to pick list or post goods issue. From there it may be sent to delivery note or packing list. Billing of sales order is created and sent to commercial invoice creation.
Expected sales order created and created sales order is confirmed. Sales order is approved, and if the credit limit exceed then sales order is blocked for delivery.
Expected sales order created and created sales order is confirmed. If L/C is received, then update said L/C in sales order and if credit limit is not exceeded delivery is created. The order is transferred to pick list or post goods issue. From there it may be sent to delivery note or packing list. Billing of sales order is created and sent to commercial invoice creation.
Expected sales order is created and created sales order is confirmed. If L/C is received, then updated L/C in sales order and if the credit limit exceeds then sales order is blocked for delivery.
Expected sales order is created and created sales order is confirmed. If L/C is not received, then sales order is blocked for delivery.

In the Pair List 570 are
Expected sales order is created and created sales order is confirmed. Sales order is approved and delivery created. Order is transferred to pick list or post goods issue. From there it may be send to delivery note or packing list. Billing of sales order is created and sent to commercial invoice creation.
Expected sales order is created and created sales order is confirmed. Sales order is approved and if credit limit is not exceeding then delivery is created. Order is transferred to pick list or post goods issue. From there it may be sent to delivery note or packing list. Billing of sales order is created and sent to commercial invoice creation.
Expected sales order created and created sales order is confirmed. Sales order is approved and if the credit limit exceeds then sales order is blocked for delivery and sent to release (Finance department). If it is approved then delivery is created. Order is transferred to pick list or post goods issue. From there it may be sent to delivery note or packing list. Billing of sales order is created and sent to commercial invoice creation.
Expected sales order is created and created sales order is confirmed. Sales order is approved and if the credit limit exceeds then sales order is blocked for delivery and sent to release (Finance department). If it is not approved the process ends.
Expected sales order is created, and created sales order is confirmed. If L/C is received, then update L/C in sales order and if the credit limit exceeds then sales order is blocked for delivery and sent to release (Finance department). If it is not approved then the process ends.
Expected sales order is created and created sales order is confirmed. If L/C is not received, then sales order is blocked for delivery and sent to release (Finance department). If it is not approved then the process ends.
Expected sales order is created and created sales order is confirmed. If L/C is received, then update L/C in sales order and if credit limit is not exceeding, delivery is created. Order is transferred to pick list or post goods issue. From there it may be sent to delivery note or packing list. Billing of sales order is created and sent for commercial invoice creation.
Expected sales order is created and created sales order is confirmed. If L/C is not received, then sales order is blocked for delivery and sent to release (Finance department). If it is approved then delivery is created. Order is transferred to pick list or post goods issue. From there it may be sent to delivery note or packing list. Billing of sales order is created and sent to commercial invoice creation.

FIG. 4c shows the detailed Test Steps 596 for each activity in the Business Process 595 of Agent Sales as generated at the Test Generator 4 by traversing through the TCAD shown in FIG. 4a. The process in the TCAD 551a, 552a, 555a, 556a, 561a, 564a forms the Test Steps 596 for the corresponding Business Process steps which are “create sales order with required inputs”, “Confirm and Save sales order”, “Receive the sales order details by Letter of Credit (L/C)”, “Creating Letter of Credit”, “If L/C is not updated in sales order the order should be blocked for delivery”, “Sales order approved by Operation Director”, “Checking the credit limit”, “Create delivery”, “Save the delivery number”, “Create and confirm the Transfer Order for the delivery”, “Enter the T-code and enter the delivery number”, “Enter in the associated pick quantity”, “Generate packing slip”, “Generate delivery note”, “post goods issue”, “Validate delivery postings”, “Create invoice”, “Create commercial print invoice”, “Release to accounting”, and “Check accounting documents”. Each process step consists of detailed Test Steps. Creating an expected sales order based on detailed Test Steps 551a that, verifies sales document type, verifies sales organization, verifies distribution channel, verifies division, verifies sold to party, verifies ship to party, and verifies stock material. Confirming and saving the sales order created based on detailed Test Steps 552a that verifies selling price to customer, verifies item availability, and validates receive the sales order details by L/C. Creating or updating the Letter of Credit (L/C) based on detailed Test Steps 564a that verifies letter of credit document type, verifies sold to party and ship to party, validates the financial document number after saving, and verifies the financial document number. Creating delivery if the credit limit has not exceeded based on detailed Test Steps 555a that verifies warehouse number, verifies movement type, verifies material number, verifies quantity, verifies unit of measure, verifies plant or storage location, verifies storage unit type, and verifies movement data from data destination. Saving the delivery number based on detailed Test Steps that click on save button, note the delivery number, and validate delivery number.

Further, Creating transfer order and confirming by generating a pick list, based on detailed Test Steps 556a that verifies warehouse number, verifies movement type, verifies material number, verifies quantity, verifies unit of measure, verifies plant or storage location, verifies storage unit type, and verifies movement data. Entering the T-code and entering the delivery number based on detailed Test Step that enters the delivery number, and hits enter. Entering in the associated pick quantity based on detailed Test Step validates picking quantity. Creating invoice based on detailed Test Steps 561a that verifies warehouse number, verifies movement type, verifies material number, verifies quantity, verifies unit of measure, verifies plant or storage location, verifies storage unit type, and verifies movement data. Creating commercial print invoice based on detailed Test Steps that clicks on ‘Save’ button to save the billing, and notes down the invoice number. Releasing to accounting based on detailed Test Steps that verifies the T-code, verifies invoice number, and clicks on ‘Green Flag’ to release accountings. Checking accounting documents based on detailed Test Steps that verifies the T-code, verifies accounting number, verifies fiscal year, and hits enter to display the accounting document.

FIG. 4d shows the Test Data Placeholders 17 that are generated which is actual Test Data used to conduct or execute the Tests, and these are also a part of the output of the present system to generate these Test Data Placeholders 17. For example, for the Agent Sales, sample Test Data Placeholders 17 includes assigning values to the fields of sales document type 571, sales organization 572, distribution channel 573, division 574, sold to party 575, ship to party 576, material 577, sales price 578, sales order number 579, shipping point 580, delivery date 581, warehouse number 582, movement type 583, material number 584, quantity 585, unit of measure 586, plant or storage location 587, storage unit type 588, from 589, destination 590, sales order 591, invoice number 592, accounting number 593, and financial year 594.

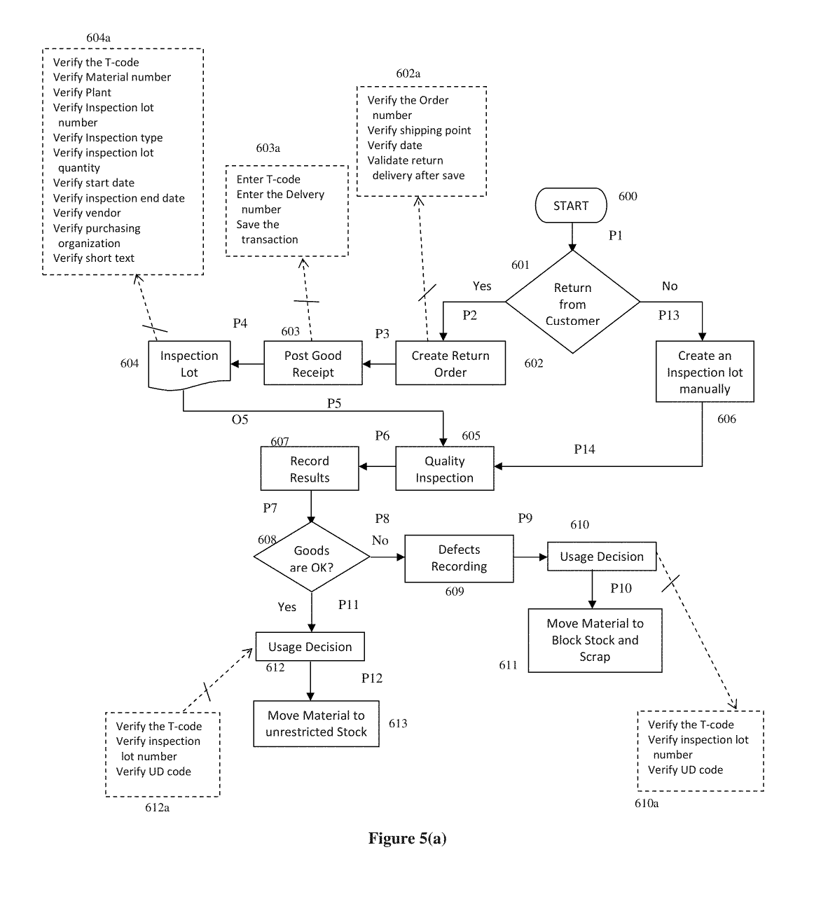

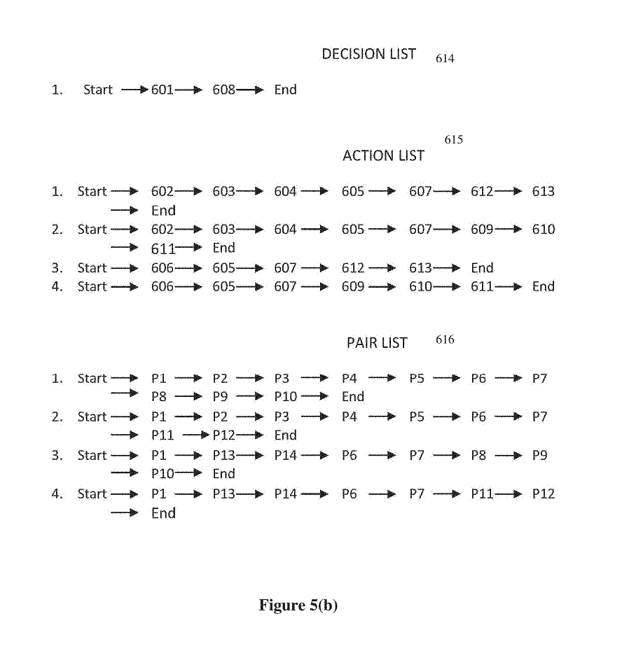

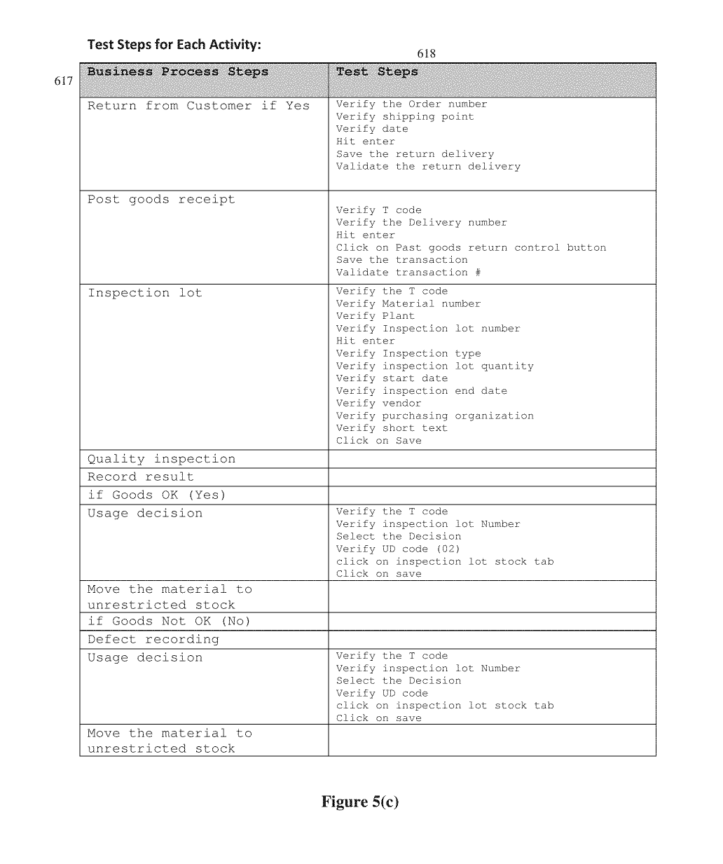

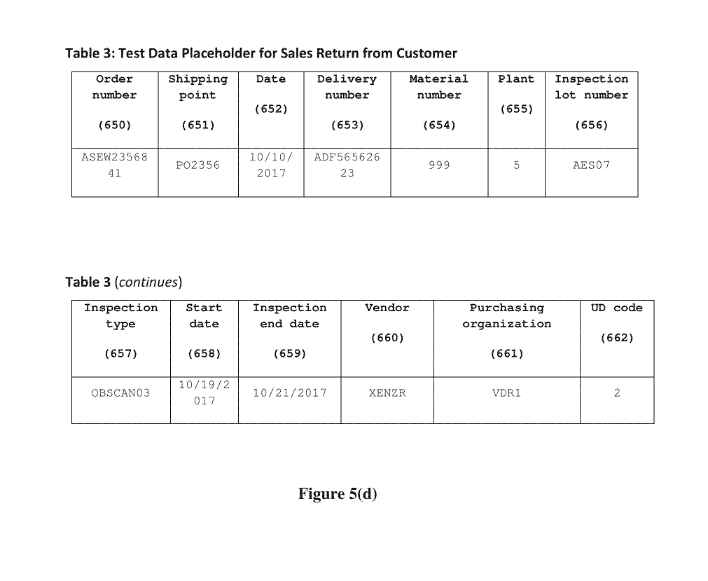

FIG. 5a shows the TCAD for the Business Process of Sales Return from Customer annotated after passing through the Parsing module and Analysis module by showing various Test Steps showed in dashed boxes 602a, 603a, 604a, 610a, 612a. Once the TCAD 10 passes through the Parsing module 2, the Action, Pair, and Decision Points are also annotated in order to assist the Test Generator in generating the Test Cases correctly.

The activities involved are started 600 when there is a return from a customer 601 which is an event, and a return delivery is created 602 by verifying order number, shipping point, date and validating the return delivery after recording into the system 602a. Thus, the customer return 601 is a Decision Node, connected to the return delivery creation 602 which is an Activity Node, by an Activity Edge. A post goods receipt 603 is generated by verifying T-code, delivery number and saving the transaction 603a. A ‘Past goods return control’ button when activated saves the transaction. The process owner for creating Return delivery 603 by generating the Post Goods receipt 604, and generating the Inspection lot, is a Sales Administrator. After PGI the returned material is forwarded to a quality inspection 605 for which an inspection lot 604 is created by validating the T-code, material number, plant inspection lot number, inspection type, quantity of inspection lot, inspection start date and end date, vendor, purchasing organization, and short text 604a. The Edge connecting the Inspection lot 604 Activity Node to the quality inspection 605 Merge Node is an Object Edge 05. If the materials are in good condition 608, a usage decision 610 is taken after verifying the T-code, inspection lot number, selecting decision, verifying generated usage decision code (UD code) 610a, and then saving through an inspection lot stock tab. The materials are then moved to an unrestricted stock 611. But if the materials are not in a good condition 608, the defects are recorded 609, and then the usage decision 612 is made after validating the T-code, inspection lot number, selecting decision, usage decision code (UD code) 612a, and the goods are moved to block stock and scrapped 613. The Nodes return delivery creation 602, Post Goods receipt 603, Creating inspection lot 606, recording results 607, recording defects 609, usage decisions 610, 612, material moved to unrestricted stock 611, and to block stock and scrap 613 all these are Activity Nodes. The Decision Nodes are return from the customer 601 and checking condition of goods 608. The Merge Node is Quality Inspection 605. All other Edges are Activity Edges except 04 which is an Object Edge. A Warehouse Clerk handles the material movement once the usage decisions 610, 612 are taken in both cases of moving to block stock and scraping, and to unrestricted stock.

If the return is not from the customer 601, an inspection lot is created manually 606 by verifying the T-code, material number, plant, inspection lot number, inspection type, inspection lot quantity, start date, inspection end date, vendor, and purchasing organization, followed by the quality inspection 605 and the results are recorded 609. Further, the process continues and based on the quality of received materials, said materials are moved either to the unrestricted stock 613 or to block stock and scrapped 611. The method resulted in the generation of nine Test Cases, which includes four Path-Based Test Cases, one Event-Based Test Case, two Error-based Test Cases, and two Expert-System based Test Cases.

FIG. 5b shows the Decision Lists, Action Lists, and Pair Lists 11 generated by the Parsing module 2 for the Business Process of Sales Return from Customer which includes a Decision List 614, Action List 615, and Pair List 616.

In the Decision List 614 are, Check if goods are return from Customer. If yes, check if materials are OK or not.

In the Action List 615 are
When materials are returned from customer, create return delivery and post goods receipt. Inspect the lot, that is quality inspection then record the results. If materials are OK, take usage decision on the materials and move material to unrestricted stock.
When materials are returned from customer, create return delivery and post goods receipt. Inspect the lot or quality inspection then record the results. If materials are not OK, defect recording is done and taking usage decision on the materials and move said materials to block stock and scrap.
When materials are not returned from customer, create an Inspection lot manually and quality inspection on materials then record the result. If materials are not OK, defects recording is done and taking usage decision on the materials, and move material to block stock and scrap.
When materials are not returned from customer, create an Inspection lot manually and quality inspection of materials then record the result. If materials are OK, taking usage decision on the materials and move material to unrestricted stock.

In the Pair List 616 are
When materials are returned from customer, create return delivery and post goods receipt. Inspect the lot or quality inspection is done, then record the results. If materials are not OK, defects recording to be done and take usage decision on the materials and move material to block stock and scrap.
When materials are returned from customer, Create return delivery and post goods receipt. Inspect the lot or quality inspection is done, then record the results. If materials are OK, take usage decision on the materials and move materials to unrestricted stock.
When materials are not returned from customer, create an Inspection lot manually and quality inspection on materials then record the result. If materials are not OK, defects recording is done and take usage decision on the materials and move material to block stock and scrap.
When materials are not returned from customer, create an Inspection lot manually and quality inspection on materials then record the results. If materials are OK, take usage decision on the materials and move material to unrestricted stock.

FIG. 5c shows the detailed process steps for each activity in the Business Process 617 as generated at the Test Generator 4 by traversing through the TCAD FIG. 5a. The process in the TCAD 602a, 603a, 604a, 610a, 612a, forms the Test Steps 618 for the corresponding Business Process steps which are “Return from customer if Yes”, “Post goods receipt”, “Inspection lot”, “Quality inspection”, “Record result”, “If Goods OK (Yes)”, “Usage decision”, “Move the material to unrestricted stock”, “If Goods Not OK (No)”, “Defect recording”, “Usage decision”, and “Move the material to unrestricted stock”.

Each process step consists of detailed Test Steps. Return from Customer if Yes, based on detailed Test Steps 602a that verifies the order number, verifies shipping point, verifies date, hits enter, saves the return delivery and validates the return delivery. Post goods receipt has Test Steps 603a that verifies T-code, verifies the delivery number, hits enter, clicks on ‘Past goods return control’ button, saves the transaction and validates transaction number. The detailed Test Steps 604a for inspection lot are, verifies the T-code, verifies material number, verifies plant, verifies inspection lot number, hits enter, verifies inspection type, verifies inspection lot quantity, verifies start date, verifies inspection end date, verifies vendor, verifies purchasing organization, verifies short text, and clicks on save. Usage decision if the Goods OK (Yes) based on detailed Test Steps 612a that verifies the T-code, verifies inspection lot number, selects the decision, verifies usage decision (UD code), clicks on inspection lot stock tab, and clicks on save. Usage decision if the Goods Not OK (No) based on detailed Test Steps 610a that verifies the T-code, verifies inspection lot number, selects the decision, verifies the UD code, clicks on inspection lot stock tab, and clicks on save.

FIG. 5d shows the Test Data Placeholders 17 that are generated which is basically actual Test Data that is used to conduct or execute the Tests and these are also a part of the output of the present system to generate these Test Data Placeholders 17. For example, for Sales Return from Customer process, sample Test Data Placeholders include assigning values to the fields of order number 650, shipping point 651, sate 652, delivery number 653, material number 654, plant 655, inspection lot number 656, inspection type 657, start date 658, inspection end date 659, vendor 660, purchasing organization 661, and UD code 662.

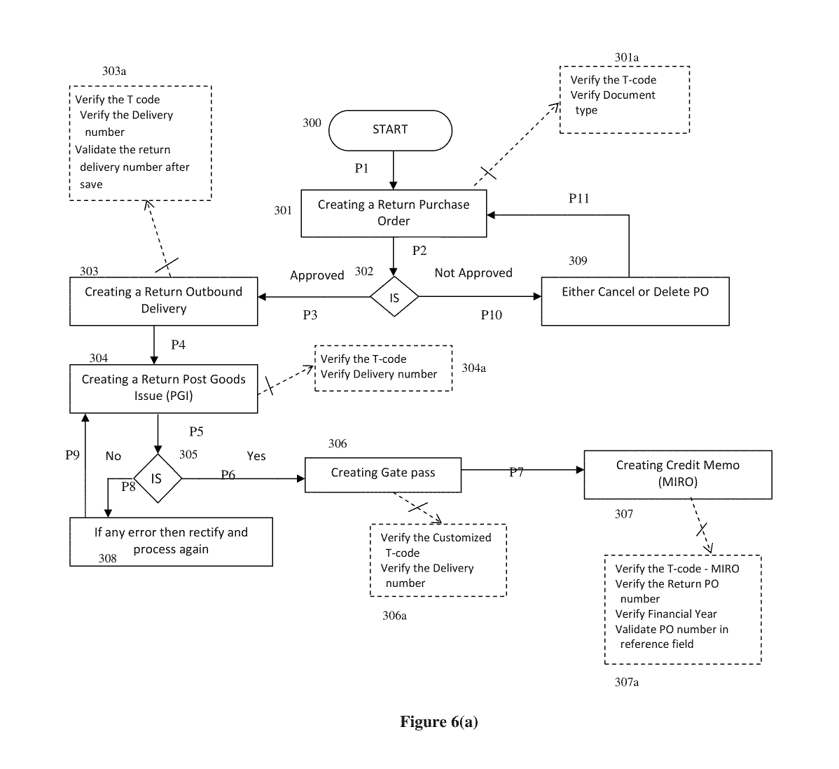

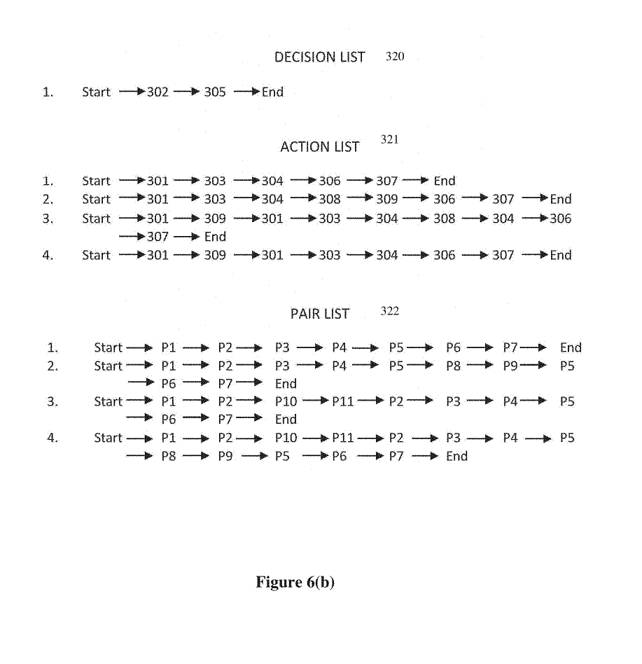

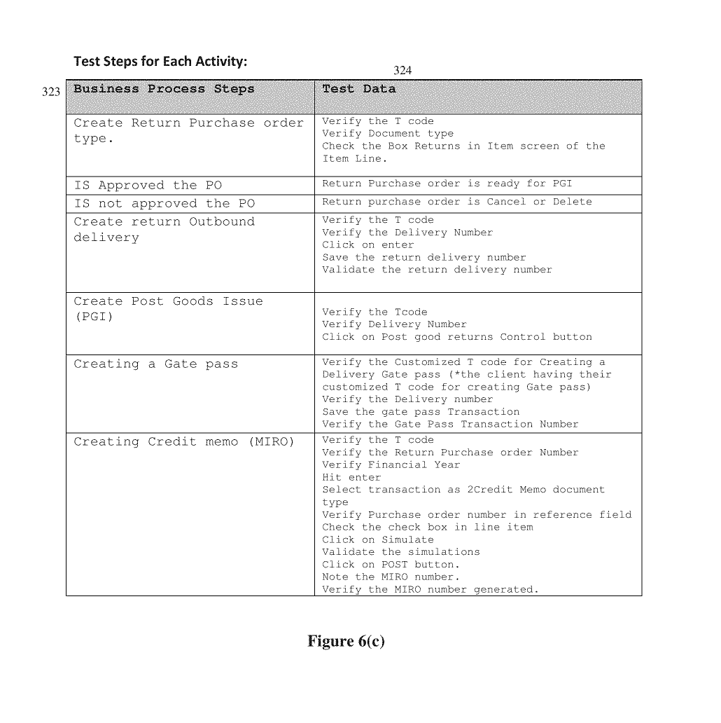

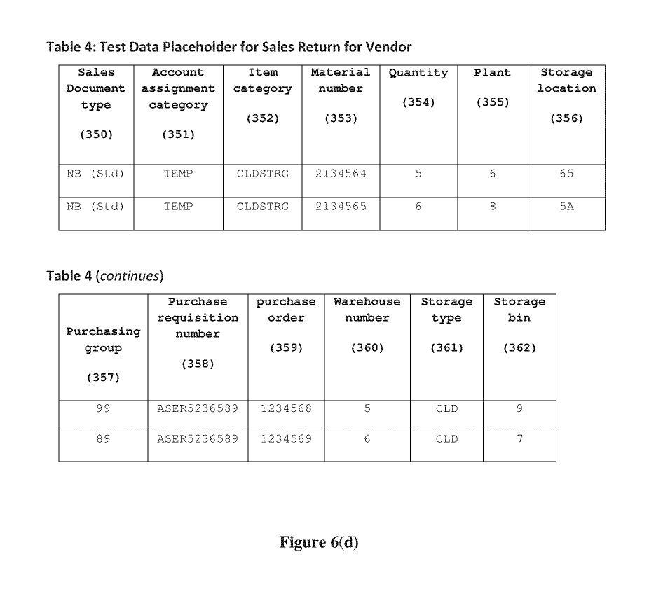

FIG. 6a shows the TCAD for the Business Process of Sales Return for Vendor annotated after passing through the Parsing module and Analysis module by showing various Test Steps showed in dashed boxes 301a, 303a, 306a, 307a. Once the TCAD 10 passes through the Parsing module 2, the Action, Pair, and Decision Points are also annotated in order to assist the Test Generator in generating the Test Cases correctly.

The process starts 300 by creating a return purchase order (PO) 301 by verifying details such as T-code, document type, and checking the “Return” box in the item screen of the item line 301a. The purchase order will be approved by the concerned department for further process. If the return purchase order is approved 302, then the post goods issue (PGI) is ready for generation. The return outbound delivery is created 303 by verifying the T-code and delivery number 303a. The return delivery number is then saved and recorded into the system, which is then validated 303a. The PGI is created by verifying the T-code and delivery number 304a, further “Post Goods returns” control button is clicked to generate the Return Post Goods Issue (PGI) 304. On getting the goods receipt 305, a customized T-code is verified 306a for creating a delivery gate pass 306, this is for a client having customized T-code.

Further the delivery number is verified 306a, the created gate pass transaction is saved and the gate pass transaction number is verified, if the PGI does not have any error 305. If PGI has any errors 305, the errors are fixed and processed again 308 to generate the gate pass 306. The credit memo (MIRO) is created 307 by verifying the T-code, return purchase order number, financial year 307a, and hitting the enter key. For completing the generation of credit memo the transaction document type is selected as “2Credit Memo”, the purchase order number in reference field is verified 307a, a check box is selected and ‘Simulate’ is clicked which validates the simulations, ‘POST’ button is selected then, the MIRO number is recorded, and the generated MIRO number is validated. But if the return purchase order is not approved 302 then said return purchase order is either cancelled or deleted 309.

The Activity Nodes are creating a return purchase order 301, creating return outbound delivery 303, creating return post goods issue 304, gate pass creation 306, credit memo 307 creation, error rectification 308, and cancellation of PO 309. The approval of return purchase order 302 and receiving post goods issue 305 are Decision Nodes. All Edges generated are Activity Edges. The method resulted in the generation of 10 Test Cases which includes 4 Path-Based Test Cases, 2 Error-based Test Cases, and 4 Expert-System Based Test Cases.

FIG. 6b shows the Decision Lists, Action Lists, and Pair Lists 11 generated by the Parsing module 2 for the Business Process of Sales Return for Vendor which includes a Decision List 320, Action List 321, and Pair List 322 wherein:

In the Decision List 320 are, check if the created return purchase order is approved or not. If it is approved, check if the return post goods issue (PGI) is created or not.

In the Action List 321 are
Create a return purchase order and if it is approved, create a return outbound delivery and return post goods issue (PGI). After creation, creating gate pass and credit memo (MIRO).
Create a return purchase order and if it is approved, create a return outbound delivery and return post goods issue (PGI). If any error then rectify by creating a return post goods issue (PGI) again and if it is created then create gate pass and credit memo (MIRO).
Create a return purchase order and if it is not approved either cancel or delete PO. Create a return purchase order and if it is approved, create a return outbound delivery and return post goods issue (PGI). If any error then rectify by creating a return post goods issue (PGI) again, and if it is created then create gate pass and credit memo (MIRO).
Create a return purchase order and if it is not approved either cancel or delete PO. Create a return purchase order and if it is approved, Create a return outbound delivery and return post goods issue (PGI). After creation, creating gate pass and credit memo (MIRO).

In the Pair List 322 are
Start by creating a return purchase order and if it is approved, create a return outbound delivery and return post goods issue (PGI). After creation, creating gate pass and credit memo (MIRO).
Start by creating a return purchase order and if it is approved, create a return outbound delivery and return post goods issue (PGI). If any error then rectify by creating a return post goods issue (PGI) again and if it is created then create gate pass and credit memo (MIRO).
Start by creating a return purchase order and if it is not approved either cancel or delete PO. Create a return purchase order and if it is approved, create a return outbound delivery and return post goods issue (PGI). If any error then rectify by creating a return post goods issue (PGI) again and if it is created then create gate pass and credit memo (MIRO).
Start by creating a return purchase order and if it is not approved either cancel or delete PO. Create a return purchase order and if it is approved, create a return outbound delivery and return post goods issue (PGI). If any error then rectify by creating a return post goods issue (PGI) again and if it is created then create gate pass and credit memo (MIRO).

FIG. 6c shows the detailed Test Steps 324 for each activity in the Business Process 323 as generated at the Test Generator 4 by traversing through the TCAD in FIG. 6a. The process in the TCAD 301a, 303a, 306a, 307a, forms the Test Steps 324 for the corresponding Business Process steps which are, “Create return purchase order type”, “Is approved the PO”, “Is not approved the PO”, “Create return outbound delivery”, “Create post goods issue (PGI)”, “Creating a gate pass”, and “Creating credit memo (MIRO)”. Create return purchase order type based on detailed Test Steps 301a that verifies the T-code, verifies document type, and checks the box returns in Item screen of the item line. IS Approved the PO based on detailed Test Step is return purchase order is ready for PGI, and for IS not approved the PO is return purchase order is cancel or delete. Create return outbound delivery based on detailed Test Steps 303a that verifies the T-code, verifies the delivery number, clicks on enter, saves the return delivery number, and validates the return delivery number. Create post goods issue (PGI) based on detailed Test Steps 304a that verifies the T-code, verifies delivery number, and clicks on post good returns control button. Creating a gate pass based on detailed Test Steps 306a that verifies the customized T-code for creating a delivery gate pass (for a client having a customized T-code for creating gate pass), verifies the delivery number, saves the gate pass Transaction, and verifies the gate pass transaction number. Creating credit memo (MIRO) based on detailed Test Steps 307a that verifies the T-code, verifies the return purchase order number, verify financial year, hits enter, selects transaction as ‘2Credit Memo’ document type, verifies Purchase order number in reference field, checks the check box in line item, clicks on ‘Simulate’, validates the simulations, clicks on POST button, notes the MIRO number, and verifies the MIRO number generated.

FIG. 6d shows the Test Data Placeholders 17 that are generated which is actual Test Data used to conduct or execute the Tests, and these are also a part of the output of the present system to generate these Test Data Placeholders 17. For example, for Sales Return for Vendor process, sample Test Data Placeholders include assigning values to the fields of sales document type 350, account assignment category 351, item category 352, material number 353, quantity 354, plant 355, storage location 356, purchasing group 357, purchase requisition number 358, purchase order 359, warehouse number 360, storage type 361, and storage bin 362.

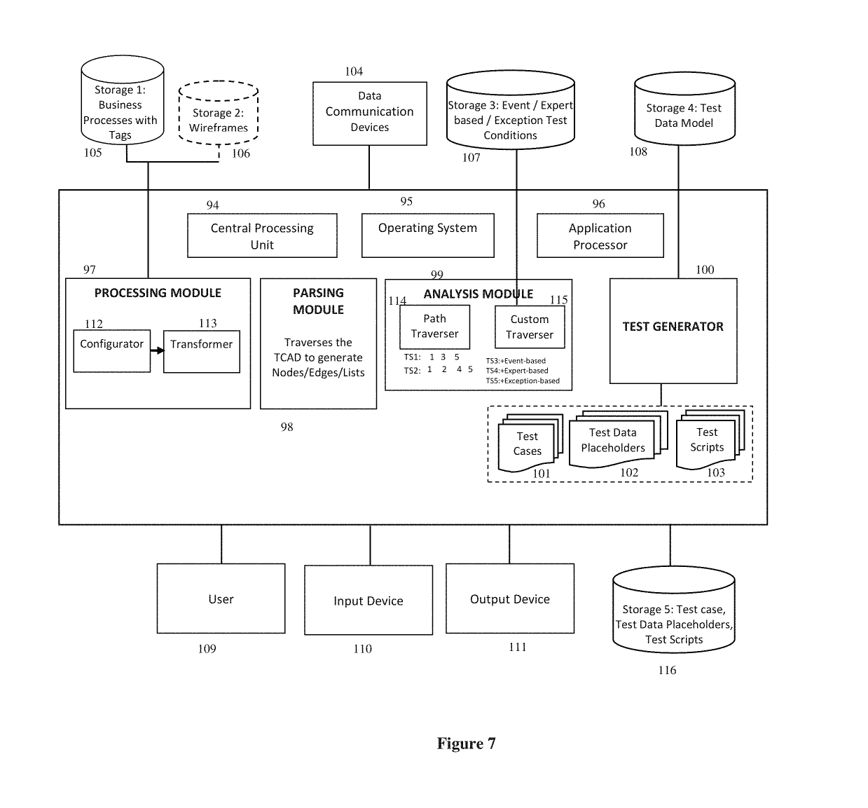

FIG. 7 describes the apparatus of the present invention that has a Central Processing Unit 94, an Operating System 95, an Application Processing module 96, a Processing module 97, a Parsing module 98, an Analysis module 99, and a Test Generator 100 as its main modules. The primary output of the apparatus is the generation of Test Cases 101, Test Data Placeholders 102 and Test Scripts 103. The apparatus communicates via Data Communication Devices 104 and works with a number of storage units 1 to 5, 105, 106, 107, 108 to take in various inputs then the Processing module 97 should generate these Test Cases 101. The apparatus also has one or more users 109, and input 110 and output devices 111. The primary function of the apparatus is to convert Business Processes with certain tags 105 taken from storage 1 and fed to the Processing module 97. Optionally, certain images stored in a Wireframes database 106 are also taken along with the Business Processes to improve the representation of the Business Process. The Processing module 97 has two sub-modules, a Configurator 111 and a Transformer 112. The Configurator 111 combines the Business Process with tags 105 along with the Wireframes 106 and sends to the Transformer 113, which then converts that into a TCAD that represent the Business Process as a graph with tags that are placed on certain Nodes of the graph. Tags can be described as quality attributes that the testing must achieve, for example, Usability, Database Response, Non-mandatory Fields, Mandatory Fields, Network Failure, Popup Blocker, Multiple Iterations, etc.

As previously mentioned, a TCAD is a focused representation of the Business Process with the various tests that should be preformed at the various logical points within the Program. For example, if there is a ‘Retry’ button within a Web page one tag that could be associated with it is the tag of ‘Usability’. So that needs to be tested when the Business Process is run through the testing phase. Therefore, the TCAD is the corner stone of the representation that this invention primarily works with. The Parsing module 98 takes the TCAD and traverses it to generate Nodes, Edges, and Lists. The Nodes within the TCAD could be Decision Nodes, Fork and Join Nodes, or Action Nodes and are primarily the three big classes of Nodes within a TCAD. The Edges are the connectors between the Nodes. The Lists refer to certain attributes that are represented in List form, for example, the decisions that might affect the flow of the Program.

The Decision, Action, and Pair Lists from the Parsing module 98 are then fed into the Analysis module 99 which has two sub-modules called the Path Traverser 114, and the Custom Traverser 115. The Path Traverser 114 is primarily generating Test Scenarios. The output of the Analysis module 99 is Test Scenarios. For example, the Path Traverser 114 might generate two valid Test Scenarios for a TCAD, Test Scenario 1 (TS1) where the Nodes 1, 3, 5 need to be traversed and Test Scenario 2 (TS2) where the Nodes 1, 3, 4, 5 needs to be traversed in order to cover the entire Program that is being executed. The Custom Traverser 115 takes inputs from the storage that has Event-Based, Expert-System Based, Exception-Based Test Conditions 107 which are then used to construct further Test Scenarios based on the different types of known testing methodologies. The Test Generator 100 takes the Test Scenarios from the Analysis module 99 and converts them into Test Condition Lists. The Test Generator 100 further uses Test Data Model 108 as inputs from storage 4 that might work in lieu with the Wireframes 106. Since the Wireframes 106 are not mandatory the Test Data Model 108 acts as a second set of clues into how the Tests might be generated for a given Business Process. The Test Generator 100 goes on to generate the Test Cases 101, Test Data Placeholders 102, Test Scripts 103 that can be used to entirely test the Business Process, and is stored in a local or a remote storage 116 in a plurality of formats including Excel, text files, etc.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A system for the generation of automated, hybrid Test Suites for at least one Business Process to measure at least one quality attribute of a system under test comprising (a) a Processing module, b) a Parsing module, (c) an Analysis module, and (d) a Test Generator, (e) a User-interface, (f) at least one Business Processes with tags, and (g) at least one Test Data Models, wherein:
a) the Processing module comprises (i) a Configurator and (ii) a Transformer, wherein the Processing module takes in the at least one Business Process with tags, which are quality attributes that the testing must achieve, via the User-interface and converts the at least one Business Process with tags into a Test-Centric Activity Diagram (TCAD);
b) the Parsing module traverses the TCAD to identify at least one type of Node and corresponding Edge to generate at least one List that annotate the TCAD for the Analysis module;
c) the Analysis module comprises (i) a Path Traverser and (ii) a Custom Traverser wherein the Analysis module generates at least one Test Scenario by representing the various paths through the at least one Business Process with tags under test in addition to the Test Scenario generated using other tests selected from the group consisting of Exception-Based, Event-Based, and Expert-System Based tests; and
d) the Test Generator takes at least one input from storage containing at least one Test Data Model and the at least one Test Scenario generated by the Analysis module to arrive at an intermediate set of Test Condition Lists and finally automated, hybrid Test Suites including (i) Test Cases, (ii) Test Data Placeholders, and (iii) Test Scripts.

2. The system of claim 1, wherein at least one Wireframe is used along with the at least one Business Process, as input to the Processing module such that:
a) the at least one Wireframe is a blueprint of the process along with the at least one Test Data Model, that is used to generate appropriate Test Suites at the Test Generator; and
b) the Configurator combines the at least one Business Process with tags with the at least one Wireframe and passes this on to the Transformer.

3. The system of claim 1, wherein the Parsing module traverses the TCAD to identify the at least one type of Nodes and corresponding Edge to generate the at least one List that annotate the TCAD with at least one Action, Pair and Decision List, wherein:
a) the at least one Node is selected from the group consisting of (i) an Action Node that carries out a specific function, (ii) a Fork and Join Node that depicts the existence of Concurrent Test Conditions, and (iii) a Decision Node where a condition is being tested to decide the path of the at least one Business Process;
b) the Parsing module detects a Node ID, Incoming and Outgoing connections for the Action, Fork and Join, and Decision Nodes, generating the corresponding Edges and the at least one List while parsing, wherein the Action Node alone goes through an additional check for the presence of tags in order to create an Action Object that is tagged;
c) the at least one Action List is an array of interconnected actions that provides all possible ways of connecting to each action, also gives a List of Incoming and Outgoing actions;
d) the at least one Pair List is an array of interconnected pairs that provides all possible ways of connecting to each pair, also gives a List of Incoming and Outgoing pairs; and
e) the at least one Decision List is an array of interconnected decisions that provides all possible ways of connecting to each decision, also gives a List of Incoming and Outgoing decisions.

4. The system of claim 1, wherein the at least one Business Process is an Ordering process represented by the abstract steps of (i) checking for the presence of the Obsolete accounts, (ii) checking for the balance in the account, (iii) drawing funds, (iv) checking if there are sufficient funds, (v) If there are sufficient funds, accepting order, (vi) sending to queue for processing, (vii) triggering acknowledgment to the customer and ending process, (viii) if there is a shortage of funds, retrying the withdrawal of funds, (ix) gathering data if retry works for the count of retry operation executed for reaching a nominal failure point, and verifying valid user, (x) rejecting order if retrying withdrawal is not successful or if a user is not valid, (xi) rolling back order processing, and (xii) triggering notification and ending process, wherein:
a) the Ordering process is assigned a plurality of tags to indicate the quality attributes that are being tested here including (i) ‘Usability’, (ii) the presence of invalid users, and (iii) ‘fault injection’;
b) the Ordering process has a TCAD generated for it, annotated after passing through the Parsing module and the Analysis module including inputs from the at least one Test Data Model, wherein:
i) checking for the balance in the account based on detailed Test Steps that (i) verifies the card number, (ii) verifies the expiry date, and (iii) verifies the CVV; and
ii) drawing funds based on detailed Test Steps that (i) verifies the correctness of obtained card details, (ii) verifies availability of sufficient funds, and (iii) verifies response code, to ensure if a user has sufficient funds, such that
A) on availability of sufficient funds
I) accepting order based on detailed Test Steps that (i) verifies order number, (ii) verifies item code, (iii) verifies item quantity, (iv) verifies details about coupons applied, (v) verifies transaction reference number, (vi) verifies total amount, and (vii) verifies the transactional amount;
II) sending the order to queue based on detailed Test Steps that (i) verifies order number, (ii) verifies shipment tracking number, (iii) verifies shipment address, and (iv) verifies transaction details; and
III) triggering acknowledgment to the customer, simultaneously, based on detailed Test Steps that (i) verifies generated acknowledgment number, (ii) verifies invoice number, and (iii) verifies ordered item and quantity; and
B) on shortage of funds
I) retrying withdrawal of funds which does a ‘Usability’ checking, based on detailed Test Steps that (i) verifies order number, and (ii) verifies card details;
II) rejecting the order based on detailed Test Steps that (i) verifies the order number, (ii) verifies reason for rejection, (iii) verifies transaction reference number, and (iv) verifies updating of order status;
III) rolling back order processing based on detailed Test Steps that (i) verifies order details, and (ii) verifies order status, and (iii) verifies that the order is not placed in such cases; and
IV) triggering notification to the customer based on detailed Test Steps that (i) verifies order number, (ii) verifies transaction reference number, (iii) verifies order status, (iv) verifies reason for rejection, (v) verifies mail or mobile number, and (vi) verifies user details;
c) the Ordering process has at least one Decision, Action, and/or Pair List generated after going through the Parsing module; and
d) the Ordering process has at least one hybrid, automated Test Suites generated including at least one feature selected from the group consisting of Test Cases, Test Data Placeholders for assigning values to the fields of order number, card number, expiry date, CVV number, item code, item quantity, coupon details, transaction amount, transaction reference number, shipment tracking number, shipment to address, shipment from address, acknowledgment number of the order, e-mail, invoice number, mobile number, order status, and reason for rejection, and Test Scripts.

5. The system of claim 1, wherein the at least one Business Process is Agent Sales represented by the abstract steps of (i) creating an expected sales order, (ii) confirming and saving the sales order created, (iii) approving the sales order, (iv) receiving sales order as letter of credit (L/C), (v) creating or updating L/C in sales order, (vi) If L/C not updated then proceeding to step xvi, (vii) checking the credit limit, if exceeding proceeding to step xvi, (viii) creating delivery if the credit limit has not exceeded, (ix) saving the delivery number, (x) creating transfer order and confirming, generating a pick list, (xi) issuing of post goods (PGI) thus generating a delivery note and a packing list, (xii) creating invoice, (xiii) generating a commercial invoice and printing, (xiv) releasing for accounting, (xv) checking accounting documents and ending process, (xvi) blocking delivery and ending process, wherein:
a) the Agent Sales process has a TCAD generated for it, annotated after passing through the Parsing module and the Analysis module including inputs from the at least one Test Data Model, wherein:
i) creating an expected sales order based on detailed Test Steps that (A) verifies sales document type, (B) verifies sales organization, (C) verifies distribution channel, (D) verifies division, (E) verifies sold to party, (F) verifies ship to party, and (G) verifies stock material;
ii) confirming and saving the sales order created based on detailed Test Steps that (A) verifies selling price to customer, (B) verifies item availability, and (C) validates receive the sales order details by L/C;
iii) creating or updating a letter of credit (L/C) based on detailed Test Steps that (A) verifies letter of credit document type, (B) verifies sold to party, and ship to party, (C) validates the financial document number after saving, and (D) verifies the financial document number;
iv) creating delivery if the credit limit has not exceeded based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data from data destination;
v) saving the delivery number based on detailed Test Steps that (A) records the delivery number, and (B) validates the delivery number;
vi) creating transfer order and confirming by generating a pick list based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data; and
vii) creating invoice based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data;
b) the Agent Sales process has at least one Decision, Action, and/or Pair List generated after going through the Parsing module; and
c) the Agent Sales process has at least one hybrid, automated Test Suites generated including at least one feature selected from the group consisting of Test Cases, Test Data Placeholders for assigning values to the fields of sales document type, sales organization, distribution channel, division, sold to party, ship to party, material, sales price, sales order number, shipping point, delivery date, warehouse number, movement type, material number, quantity, unit of measure, plant or storage location, storage unit type, from, destination, sales order, invoice number, accounting number, and financial year, and Test Scripts.

6. The system of claim 1, wherein the at least one Business Process is Sales Return from Customer represented by the abstract steps of (i) checking for return from a Customer, (ii) if returns received from the customer, then creating return order, (iii) creating post goods receipt, (iv) creating an inspection lot, (v) inspecting for quality of returned goods, (vi) recording inspection results, (vii) checking for quality of goods, (viii) generating an usage decision if goods quality is fine, (ix) moving material to unrestricted stock, (x) recording defect details if quality of goods are not fine, (xi) creating a usage decision, (xii) moving material to block stock and scrap, and (xiii) creating a manual inspection lot if returns are not from Customer and continuing steps v through xii as required, wherein:
a) the Sales Return from Customer process has a TCAD generated for it, annotated after passing through the Parsing module and the Analysis module including inputs from the at least one Test Data Model, wherein:
i) creating return order based on detailed Test Steps that (A) verifies the order number, (B) verifies shipping point, (C) verifies date, and (D) validates return delivery after saving;
ii) creating post goods receipt based on detailed Test Steps that (A) verifies T-code, (B) verifies the delivery number, (C) saves the transaction, and (D) validates the transaction number;
iii) creating an inspection lot based on detailed Test Steps, (A) verifies the T-code, (B) verifies material number, (C) verifies plant, (D) verifies inspection lot number, (E) verifies inspection type, (F) verifies inspection lot quantity, (G) verifies start date, (H) verifies inspection end date, (I) verifies vendor, (J) verifies purchasing organization, and (K) verifies short text;
iv) generating a Usage Decision if goods quality is fine based on detailed Test Steps that (A) verifies the T-code, (B) verifies inspection lot number, and (C) verifies usage decision (UD) code; and
v) creating a usage decision if goods quality is not fine, based on detailed Test Steps that (A) verifies T-code, (B) verifies inspection lot number, and (C) verifies UD code;
b) the Sales Return from Customer process has at least one Decision, Action, and/or Pair List generated after going through the Parsing module; and
c) the Sales Return from Customer process has at least one hybrid, automated Test Suites generated including at least one feature selected from the group consisting of Test Cases, Test Data Placeholders for assigning values to the fields of order number, shipping point, date, delivery number, material number, plant, inspection lot number, inspection type, start date, inspection end date, vendor, purchasing organization, and UD code, and Test Scripts.

7. The system of claim 1, wherein the at least one Business Process is a Sales Return for Vendor represented by the abstract steps of (i) creating a return purchase order (PO), (ii) checking approval of return PO, (iii) if not approved, either canceling or deleting PO generated, (iv) creating a return outbound delivery, if the return PO is approved, (v) creating a return post goods issue (PGI), (vi) verifying the return PGI, (vii) rectifying the error in the return PGI to proceed further, if there is any error, (viii) creating a gate pass if the return PGI is correct, (viii) creating a credit memo (MIRO), wherein:
a) the Sales Return for Vendor process has a TCAD generated for it, annotated after passing through the Parsing module and the Analysis module including inputs from the at least one Test Data Model, wherein:
i) creating a Return Purchase Order (PO) based on detailed Test Steps that (A) verifies T-code and (B) verifies Document type; and
ii) checking approval of return PO, if approved,
A) creating a return outbound delivery based on detailed Test Steps that (a) verifies the T-code, (b) verifies the delivery number, and (c) validates the return delivery number after saving;
B) creating a return post goods issue (PGI) based on detailed Test Steps that (a) verifies the T-code and (b) verifies the delivery number, continue if no error;
C) creating a gate pass if the return PGI is correct based on detailed Test Steps that (a) verifies the customized T-code for creating a delivery gate pass, (b) verifies the delivery number, and (c) verifies the gate pass transaction number once saved; and
D) creating a credit memo (MIRO) based on detailed Test Steps that (a) verifies the T-code in MIRO, (b) verifies the return PO number, (c) verifies financial year, and (d) validates PO number in reference field;
b) the Sales Return for Vendor process has at least one Decision, Action, and/or Pair List generated after going through the Parsing module; and
c) the Sales Return for Vendor process has at least one hybrid, automated Test Suites generated including at least one feature selected from the group consisting of Test Cases, Test Data Placeholders for assigning values to the fields of sales document type, account assignment category, item category, material number, quantity, plant, storage location, purchasing group, purchase requisition number, purchase order, warehouse number, storage type, and storage bin, and Test Scripts.

8. A computer-implemented method for the generation of automated, hybrid Test Suites for at least one Business Process to measure at least one quality attribute of a system under test having (a) a User-interface, (b) at least one Business Process with tags, and (c) at least one Test Data Model, comprising the steps of:
a) processing including Configuration and Transformation via a computer, at least one Business Process with tags, which are quality attributes that the testing must achieve, are taken as input via the User-interface and converted into a Test-Centric Activity Diagram (TCAD);
b) parsing which traverses the TCAD to identify at least one type of Node and corresponding Edges to generate at least one List that annotate the TCAD for analysis using a computer;
c) analysis using a computer, having Path Traversal and Custom Traversal wherein the analysis step generates at least one Test Scenario by representing the various paths through the at least one Business Process under test in addition to at least one Test Scenario generated using other hybrid tests selected from the group consisting of Exception-Based, Event-Based, and Expert-System Based Tests; and
d) test Generation using a computer, that takes at least one input from storage containing at least one Test Data Model and the at least one Test Scenario generated during analysis to arrive at an intermediate set of Test Condition Lists and finally automated, hybrid Test Suites including (i) Test Cases, (ii) Test Data Placeholders, and (iii) Test Scripts.

9. The computer-implemented method of claim 8, further comprising using at least one Wireframe along with the at least one Business Process with tags, as input to the processing step, such that:
a) the at least one Wireframe is a blueprint of the process along with the at least one Test Data Model, that is used to generate an appropriate one of the Test Suites at the Test Generation; and
b) during configuration, the at least one Business Process with tags is combined with the at least one wireframe and used as input to the transformation step, which generates the TCAD.

10. The computer-implemented method of claim 8, wherein the step of parsing traverses the TCAD to identify the at least one type of Node and the corresponding Edges to generate the ate least one List that annotate the TCAD with at least one Action, Pair, and Decision List, wherein:
a) the at least one type of Node is selected from the group consisting of (i) an Action Node that carries out a specific function, (ii) Fork and Join Node that depicts the existence of Concurrent Test Conditions, and (iii) Decision Node where a condition is being tested to decide the path of the at least one Business Process;
b) during Parsing, the method detects a Node ID, Incoming and Outgoing connections for the Action, Fork and Join, and Decision Nodes, generating the corresponding Edges and the at least one List, wherein the Action Node alone goes through an additional check for the presence of tags in order to create Action Objects that are tagged;
c) the Action List is an array of interconnected actions that provides all possible ways of connecting to each action, also gives a List of Incoming and Outgoing actions;
d) the Pair List is an array of interconnected pairs that provides all possible ways of connecting to each pair, also gives a List of Incoming and Outgoing pairs; and
e) the Decision List is an array of interconnected decisions that provides all possible ways of connecting to each decision, also gives a List of Incoming and Outgoing decisions.

11. The computer-implemented method of claim 8, wherein the at least one Business Process is Ordering represented by the abstract steps of (i) checking for the presence of the Obsolete accounts, (ii) checking for the balance in the account, (iii) drawing funds, (iv) checking if there are sufficient funds, (v) if there are sufficient funds, accepting order, (vi) sending to queue for processing, (vii) triggering acknowledgment to the customer and ending process, (viii) if there is a shortage of funds, retrying the withdrawal of funds, (ix) gathering data if retry works for the count of retry operation executed for reaching a nominal failure point, and verifying valid user, (x) rejecting order if retrying withdrawal is not successful or if a user is not valid, (xi) rolling back order processing, and (xii) triggering notification and ending process, wherein:
a) the Ordering process is assigned a plurality of tags to indicate the quality attributes that are being tested here including (i) ‘Usability’, (ii) the presence of invalid users, and (iii) ‘fault injection’;
b) the Ordering process has a TCAD generated for it, annotated after passing through the Parsing step and the Analysis step including inputs from the at least one Test Data Model, wherein:
i) checking for the balance in the account based on detailed Test Steps that (i) verifies the card number, (ii) verifies the expiry date, and (iii) verifies the CVV; and
ii) drawing funds based on detailed Test Steps that (i) verifies the correctness of obtained card details, (ii) verifies availability of sufficient funds, and (iii) verifies response code, to ensure if a user has sufficient funds, such that,
A) on availability of sufficient funds
I) accepting order based on detailed Test Steps that (i) verifies order number, (ii) verifies item code, (iii) verifies item quantity, (iv) verifies details about coupons applied, (v) verifies transaction reference number, (vi) verifies total amount, and (vii) verifies the transactional amount;
II) sending the order to queue based on detailed Test Steps that (i) verifies order number, (ii) verifies shipment tracking number, (iii) verifies shipment address, and (iv) verifies transaction details; and
III) triggering acknowledgment to the customer, simultaneously, based on detailed Test Steps that (i) verifies generated acknowledgment number, (ii) verifies invoice number, and (iii) verifies ordered item and quantity; and
B) on shortage of funds
I) retrying withdrawal of funds which does a ‘Usability’ checking, based on detailed Test Steps that (i) verifies order number and (ii) verifies card details;
II) rejecting the order based on detailed Test Steps that (i) verifies the order number, (ii) verifies reason for rejection, (iii) verifies transaction reference number, and (iv) verifies updating of order status;
III) rolling back order processing based on detailed Test Steps that (i) verifies order details, and (ii) verifies order status, and (iii) verifies that the order is not placed in such cases; and
IV) triggering notification to the customer based on detailed Test Steps that (i) verifies order number, (ii) verifies transaction reference number, (iii) verifies order status, (iv) verifies reason for rejection, (v) verifies mail or mobile number, and (vi) verifies user details;
c) the Ordering process has at least one Decision, Action, and Pair List generated after going through the Parsing; and
d) the Ordering process has hybrid, automated Test Suites generated including at least one feature selected from the group consisting of Test Cases, Test Data Placeholders for assigning values to the fields of order number, card number, expiry date, CVV number, item code item quantity, coupon details, transaction amount, transaction reference number, shipment tracking number, shipment to address, shipment from address, acknowledgment number of the order, e-mail, invoice number, mobile number, order status, and reason for rejection, and Test Scripts.

12. The computer-implemented method of claim 8, wherein the at least one Business Process is Agent Sales represented by the abstract steps of (i) creating an expected sales order, (ii) confirming and saving the sales order created, (iii) approving the sales order, (iv) receiving sales order as letter of credit (L/C), (v) creating or updating L/C in sales order, (vi) if L/C not updated then proceeding to step xvi, (vii) checking the credit limit, if exceeding proceeding to step xvi, (viii) creating delivery if the credit limit has not exceeded, (ix) saving the delivery number, (x) creating transfer order and confirming, generating a pick list, (xi) issuing of post goods (PGI) thus generating a delivery note and a packing list, (xii) creating invoice, (xiii) generating a commercial invoice and printing, (xiv) releasing for accounting, (xv) checking accounting documents and ending process, and (xvi) blocking delivery and ending process, wherein:
a) the Agent Sales process has a TCAD generated for it, annotated after passing through the Parsing step and the Analysis step including inputs from the at least one Test Data Model, wherein:
i) creating an expected sales order based on detailed Test Steps that (A) verifies sales document type, (B) verifies sales organization, (C) verifies distribution channel (D) verifies division, (E) verifies sold to party, (F) verifies ship to party, and (G) verifies stock material;
ii) confirming and saving the sales order created based on detailed Test Steps that (A) verifies selling price to customer, (B) verifies item availability, and (C) validates receive the sales order details by L/C;
iii) creating or updating a letter of credit (L/C) based on detailed Test Steps that (A) verifies letter of credit document type, (B) verifies sold to party, and ship to party, (C) validates the financial document number after saving, and (D) verifies the financial document number;
iv) creating delivery if the credit limit has not exceeded based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data from data destination;
v) saving the delivery number based on detailed Test Steps that (A) records the delivery number and (B) validates the delivery number;
vi) creating transfer order and confirming by generating a pick list based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data; and
vii) creating invoice based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data;
b) the Agent Sales process has at least one Decision, Action, and/or Pair List generated after going through the Parsing; and
c) the Agent Sales process has hybrid, automated Test Suites generated including at least one feature selected from the group consisting of Test Cases, Test Data Placeholders for assigning values to the fields of sales document type, sales organization, distribution channel, division, sold to party, ship to party, material, sales price, sales order number, shipping point, delivery date, warehouse number, movement type, material number, quantity, unit of measure, plant or storage location, storage unit type, from, destination, sales order, invoice number, accounting number, and financial year, and Test Scripts.

13. The computer-implemented method of claim 8, wherein the at least one Business Process is Sales Return from Customer represented by the abstract steps of (i) checking for return from a customer, (ii) if returns received from the customer, then creating return order, (iii) creating post goods receipt, (iv) creating an inspection lot, (v) inspecting for quality of returned goods, (vi) recording inspection results, (vii) checking for quality of goods, (viii) generating an usage decision if goods quality is fine, (ix) moving material to unrestricted stock, (x) recording defect details if quality of goods are not fine, (xi) creating a usage decision, (xii) moving material to block stock and scrap, and (xiii) creating a manual inspection lot if returns are not from customer and continuing steps v through xii as required, wherein:
a) the Return from Customer process has a TCAD generated for it, after passing through the Parsing step and the Analysis step including inputs from the at least one Test Data Model, wherein:
(i) creating return order based on detailed Test Steps that (A) verifies the order number, (B) verifies shipping point, (C) verifies date, and (D) validates return delivery after saving;
(ii) creating post goods receipt based on detailed Test Steps that (A) verifies T-code, (B) verifies the delivery number, (C) saves the transaction, and (D) validates the transaction number;
(iii) creating an inspection lot based on detailed Test Steps, (A) verifies the T-code, (B) verifies material number, (C) verifies plant, (D) verifies inspection lot number, (E) verifies inspection type, (F) verifies inspection lot quantity, (G) verifies start date, (H) verifies inspection end date, (I) verifies vendor, (J) verifies purchasing organization, and (K) verifies short text;
(iv) generating a Usage Decision if goods quality is fine based on detailed Test Steps that (A) verifies the T-code, (B) verifies inspection lot number, and (C) verifies usage decision (UD) code; and
(v) creating a usage decision if goods quality is not fine, based on detailed Test Steps that (A) verifies T-code, (B) verifies inspection lot number, and (C) verifies UD code;
b) the Sales Return from Customer process has at least one Decision, Action, and/or Pair List generated after going through the Parsing; and
c) the Sales Return from Customer process has hybrid, automated Test Suites generated including at least one feature selected from the group consisting of Test Cases, Test Data Placeholders for assigning values to the fields of order number, shipping point, date, delivery number, material number, plant, inspection lot number, inspection type, start date, inspection end date, vendor, purchasing organization, and UD code, and Test Scripts.

14. The computer-implemented method of claim 8, wherein the at least one Business Process is Sales Return for Vendor represented by the abstract steps of (i) creating a return purchase order (PO), (ii) checking approval of return PO, (iii) if not approved, either canceling or deleting PO generated, (iv) creating a return outbound delivery, if the return PO is approved, (v) creating a return post goods issue (PGI), (vi) verifying the return PGI, (vii) rectifying the error in the return PGI to proceed further, if there is any error, (viii) creating a gate pass if the return PGI is correct, and (viii) creating a credit memo (MIRO), wherein:
a) the Sales Return for Vendor process has a TCAD generated for it, annotated after passing through the Parsing step and the Analysis step including inputs from the at least one Test Data Model, wherein:
i) creating a return purchase order (PO) based on detailed Test Steps that (A) verifies T-code and (B) verifies Document type; and
ii) checking approval of return PO, if approved
A) creating a return outbound delivery based on detailed Test Steps that (a) verifies the T-code, (b) verifies the delivery number, and (c) validates the return delivery number after saving;
B) creating a return post goods issue (PGI) based on detailed Test Steps that (a) verifies the T-code and (b) verifies the delivery number, continue if no error;
C) creating a gate pass if the return PGI is correct based on detailed Test Steps that (a) verifies the customized T-code for creating a delivery gate pass, (b) verifies the delivery number, and (c) verifies the gate pass transaction number once saved; and
D) creating a credit memo (MIRO) based on detailed Test Steps that (a) verifies the T-code in MIRO, (b) verifies the return PO number, (c) verifies financial year, and (d) validates PO number in reference field;
b) the Sales Return for Vendor process has at least one Decision, Action, and/or Pair List generated after going through the Parsing;
c) the Sales Return for Vendor process has hybrid, automated Test Suites generated including at least one of a feature selected from the group consisting of Test Cases, Test Data Placeholders for assigning values to the fields of sales document type, account assignment category, item category, material number, quantity, plant, storage location, purchasing group, purchase requisition number, purchase order, warehouse number, storage type, and storage bin, and Test Scripts.

15. An apparatus for the generation of automated, hybrid Test Suites for at least one Business Process to measure at least one quality attribute of a system under test comprising (a) a Processing module, (b) a Parsing module, (c) an Analysis module, (d) a Test Generator, (e) a user-interface, (f) a plurality of storage units, (g) a plurality Data Communication devices, (h) a user, (i) an input device, (j) an output device, (k) an operating system, (I) a central processing unit, and (m) an application processing module, wherein:
a) the Processing module comprises (i) a Configurator and (ii) a Transformer, wherein the Processing module takes in at least one Business Process with tags, which are quality attributes that the testing must achieve, via the user-interface and converts it into a TCAD;
b) the Parsing module traverses the TCAD to identify at least one type of Nodes and corresponding Edges to generate at least one List that annotate the TCAD for the Analysis module;
c) the Analysis module comprises (i) a Path Traverser and (ii) a Custom Traverser, wherein the Analysis module generates at least one Test Scenario by representing the various paths through the at least one Business Process under test in addition to test scenarios generated using other hybrid Tests selected from the group consisting of Exception-based, Event-based, and Expert-system based tests;
d) the Test Generator takes at least one input from storage containing at least one Test Data Model and the at least one Test Scenario generated by the Analysis module to arrive at an intermediate set of Test Condition Lists and finally automated, hybrid Test Suites including (i) Test Cases, (ii) Test Data Placeholders, and (iii) Test Scripts; and
e) the storage units are used to store (i) the at least one Business Process with tags, (ii) Hybrid Test Conditions, (iii) the at least one Test Data Model, and (iv) Hybrid Test Suites.

16. The apparatus of claim 15, further comprising at least one Wireframe used along with the at least one Business Process with tags, as input to the Processing module, such that:
a) the at least one Wireframe is a blueprint of the process along with the at least one Test Data Model, that is used to generate appropriate Test Suites at the Test Generator; and
b) the Configurator combines the at least one Business Process with tags with the at least one Wireframe and passes this on to the Transformer.

17. The apparatus of claim 15, wherein the Parsing module traverses the TCAD to identify at least one type of Nodes and corresponding Edges to generate at least one List that annotate the TCAD with at least one Action, Pair, and/or Decision List, wherein:
a) the at least one type of Nodes is selected from the group consisting of (i) an Action Node that carries out a specific function, (ii) a Fork and Join Node that depicts the existence of concurrent Test Conditions, and (iii) a Decision Node where a condition is being tested to decide the path of the at least one Business Process;
b) the Parsing module detects a Node ID, incoming and outgoing connections for the Action, Fork and Join, and Decision Nodes, generating the at least one Edge and the at least one List while parsing wherein the Action Nodes alone go through an additional check for the presence of tags in order to create Action Objects that are tagged;
c) the Action List is an array of interconnected actions that provides all possible ways of connecting to each action, also gives a List of Incoming and Outgoing actions;
d) the Pair List is an array of interconnected pairs that provides all possible ways of connecting to each pair, also gives a List of Incoming and Outgoing pairs; and
e) the Decision List is an array of interconnected decisions that provides all possible ways of connecting to each decision, also gives a List of Incoming and Outgoing decisions;

18. The apparatus of claim 15, where the at least one Business Process is Ordering represented by the abstract steps of steps of (i) checking for the presence of Obsolete accounts, (ii) checking for the balance in the account, (iii) drawing funds, (iv) checking if there are sufficient funds, (v) if there are sufficient funds, accepting order, (vi) sending to queue for processing, (vii) triggering acknowledgment to the customer and ending process, (viii) if there is a shortage of funds, retrying the withdrawal of funds, (ix) gathering data if retry works for the count of retry operation executed for reaching a nominal failure point, and verifying valid user, (x) rejecting order if retrying withdrawal is not successful or if a user is not valid, (xi) rolling back order processing, and (xii) triggering notification and ending process, wherein:
a) the Ordering process is assigned a plurality of tags to indicate the quality attributes that are being tested here including (i) ‘Usability’, (ii) the presence of invalid users, and (iii) ‘fault injection’;
b) the Ordering process has a TCAD generated for it, annotated after passing through the Parsing module and the Analysis module including inputs from the at least one Test Data Model, wherein:
i) checking for the balance in the account based on detailed Test Steps which are (i) verifies the card number, (ii) verifies the expiry date, and (iii) verifies the CVV; and
ii) drawing funds based on detailed Test Steps which are (i) verifies the correctness of obtained card details, (ii) verifies availability of sufficient funds, and (iii) verifies response code, to ensure if a user has sufficient funds, such that,
A) on availability of sufficient funds
I) accepting order based on detailed Test Steps that (i) verifies order number, (ii) verifies item code, (iii) verifies item quantity, (iv) verifies details about coupons applied, (v) verifies transaction reference number, (vi) verifies total amount, and (vii) verifies the transactional amount;
II) sending the order to queue based on detailed Test Steps that (i) verifies order number, (ii) verifies shipment tracking number, (iii) verifies shipment address, and (iv) verifies transaction details; and
III) triggering acknowledgment to the customer, simultaneously, based on detailed Test Steps that (i) verifies generated acknowledgment number, (ii) verifies invoice number, and (iii) verifies ordered item and quantity; and
B) on shortage of funds
I) retrying funds which does a ‘Usability’ checking, based on detailed Test Steps which are (i) verifies order number and (ii) verifies card details;
II) rejecting the order based on detailed Test Steps that (i) verifies the order number, (ii) verifies reason for rejection, (iii) verifies transaction reference number, and (iv) verifies updating of order status;
III) rolling back order processing based on detailed Test Steps which are (i) verifies the order details, (ii) verifies the order status, and (iii) verifies that the order is not placed in such cases; and
IV) triggering notification to the customer based on detailed Test Steps that (i) verifies the order number, (ii) verifies the transaction reference number, (iii) verifies the order status, (iv) verifies reason for rejection, (v) verifies mail or mobile number, and (vi) verifies user details;
c) the Ordering process has at least one Decision, Action, and/or Pair List generated after going through the Parsing module; and
d) the Ordering process has hybrid, automated Test Suites generated including at least one feature selected from the group consisting of Test Cases, Test Data Placeholders for assigning values to the fields of order number, card number, expiry date, CVV number, item code, item quantity, coupon details, transaction amount, transaction reference number, shipment tracking number, shipment to address, shipment from address, acknowledgment number of the order, e-mail, invoice number, mobile number, order status, and reason for rejection, and Test Scripts.

19. The apparatus of claim 15, wherein the at least one Business Process is Agent Sales represented by the abstract steps of (i) creating an expected sales order, (ii) confirming and saving the sales order created, (iii) approving the sales order, (iv) receiving sales order as letter of credit (L/C), (v) creating or updating L/C in sales order, (vi) if L/C not updated then proceeding to step xvi, (vii) checking the credit limit, if exceeding proceeding to step xvi, (viii) creating delivery if the credit limit has not exceeded, (ix) saving the delivery number, (x) creating transfer order and confirming, generating a pick list, (xi) issuing of post goods (PGI) thus generating a delivery note and a packing list, (xii) creating invoice, (xiii) generating a commercial invoice and printing, (xiv) releasing for accounting, (xv) checking accounting documents and ending process, (xvi) blocking delivery and ending process, wherein:
a) the Agent Sales process has a TCAD generated for it, annotated after passing through the Parsing module and the Analysis module including inputs from the at least one Test Data Model:
i) creating an expected sales order based on detailed Test Steps that (A) verifies sales document type, (B) verifies sales organization, (C) verifies distribution channel, (D) verifies division, (E) verifies sold to party, (F) verifies ship to party, and (G) verifies stock material;
ii) confirming and saving the sales order created based on detailed Test Steps that (A) verifies selling price to customer, (B) verifies item availability, and (C) validates receive the sales order details by L/C;
iii) creating or updating a letter of credit (L/C) based on detailed Test Steps that (A) verifies letter of credit document type, (B) verifies sold to party, and ship to party, (C) validates the financial document number after saving, and (D) verifies the financial document number;
iv) creating delivery if the credit limit has not exceeded based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data from data destination;
v) saving the delivery number based on detailed Test Steps that (A) records the delivery number and (B) validates the delivery number;
vi) creating transfer order and confirming by generating a pick list based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data; and
vii) creating invoice based on detailed Test Steps that (A) verifies warehouse number, (B) verifies movement type, (C) verifies material number, (D) verifies quantity, (E) verifies unit of measure, (F) verifies plant or storage location, (G) verifies storage unit type, and (H) verifies movement data;
b) the Agent Sales process has at last one Decision, Action, and/or Pair List generated after going through the Parsing module; and
c) the Agent Sales process has hybrid, automated Test Suites generated including at least one feature selected from the group consisting of Test Cases, Test Data Placeholders for assigning values to the fields of sales document type, sales organization, distribution channel, division, sold to party, ship to party, material, sales price, sales order number, shipping point, delivery date, warehouse number, movement type, material number, quantity, unit of measure, plant or storage location, storage unit type, from, destination, sales order, invoice number, accounting number, and financial year, and Test Scripts.

20. The apparatus of claim 15, wherein the at least one Business Process is Sales Return from Customer represented by the abstract steps of (i) checking for return from a customer, (ii) if returns received from the customer, then creating return order, (iii) creating post goods receipt, (iv) creating an inspection lot, (v) inspecting for quality of returned goods, (vi) recording inspection results, (vii) checking for quality of goods, (viii) generating an usage decision if goods quality is fine, (ix) moving material to unrestricted stock, (x) recording defect details if quality of goods are not fine, (xi) creating a usage decision, (xii) moving material to block stock and scrap, and (xiii) creating a manual inspection lot if returns are not from customer and continuing steps v through xii as required, wherein:
a) the Sales Return from Customer process has a TCAD generated for it, annotated after passing through the Parsing module and the Analysis module including inputs from the at least one Test Data Model:
i) creating return order based on detailed Test Steps that (A) verifies the order number, (B) verifies shipping point, (C) verifies date, and (D) validates return delivery after saving;
ii) creating post goods receipt based on detailed Test Steps that (A) verifies T-code, (B) verifies the delivery number, (C) saves the transaction, and (D) validates the transaction number;
iii) creating an inspection lot based on detailed Test Steps that (A) verifies the T-code, (B) verifies material number, (C) verifies plant, (D) verifies inspection lot number, (E) verifies inspection type, (F) verifies inspection lot quantity, (G) verifies start date, (H) verifies inspection end date, (I) verifies vendor, (J) verifies purchasing organization, and (K) verifies short text;
iv) generating a Usage Decision if goods quality is fine based on detailed Test Steps that (A) verifies the T-code, (B) verifies inspection lot number, and (C) verifies usage decision (UD) code; and
v) creating a usage decision if goods quality is not fine, based on detailed Test Steps that (A) verifies T-code, (B) verifies inspection lot number, and (C) verifies UD code;
b) the Sales Return from Customer process has at least one Decision, Action, and/or Pair List generated after going through the Parsing module; and
c) the Sales Return from Customer process has hybrid, automated Test Suites generated including at least one feature selected from the group consisting of Test Cases, Test Data Placeholders for assigning values to the fields of order number, shipping point, date, delivery number, material number, plant, inspection lot number, inspection type, start date, inspection end date, vendor, purchasing organization, and UD code, and Test Scripts.

21. The apparatus of claim 15, wherein the at least one Business Process is Sales Return for Vendor represented by the abstract steps of (i) creating a return purchase order (PO), (ii) checking approval of return PO, (iii) if not approved, either canceling or deleting PO generated, (iv) creating a return outbound delivery, if the return PO is approved, (v) creating a return post goods issue (PGI), (vi) verifying the return PGI, (vii) rectifying the error in the return PGI to proceed further, if there is any error, (viii) creating a gate pass if the return PGI is correct, and (viii) Creating a credit memo (MIRO), wherein:
a) the Sales Return for Vendor process has a TCAD generated for it, annotated after passing through the Parsing module and the Analysis module including inputs from the at least one Test Data Model:
i) creating a return purchase order (PO) based on detailed Test Steps that (A) verifies T-code and (B) verifies Document type; and
ii) checking approval of return PO, if approved,
A) creating a return outbound delivery based on detailed Test Steps that (a) verifies the T-code, (b) verifies the delivery number, and (c) validates the return delivery number after saving;
B) creating a return post goods issue (PGI) based on detailed Test Steps that (a) verifies the T-code and (b) verifies the delivery number, continue if no error;
C) creating a gate pass if the return PGI is correct based on detailed Test Steps that (a) verifies the customized T-code for creating a delivery gate pass, (b) verifies the delivery number, and (c) verifies the gate pass transaction number once saved; and
D) creating a credit memo (MIRO) based on detailed Test Steps that (a) verifies the T-code in MIRO, (b) verifies the return PO number, (c) verifies financial year, and (d) validates PO number in reference field;
b) the Sales Return for Vendor process has at least one Decision, Action, and/or Pair List generated after going through the Parsing module; and
c) the Sales Return for Vendor process has hybrid, automated Test Suites generated including at least one feature selected from the group consisting of Test Cases, Test Data Placeholders for assigning values to the fields of sales document type, account assignment category, item category, material number, quantity, plant, storage location, purchasing group, purchase requisition number, purchase order, warehouse number, storage type, and storage bin, and Test Scripts.
